(19) United States
(12) Patent Application Publication
(10) Pub. No.: US 2022/0124795 A1
(43) Pub. Date: Apr. 21, 2022

(54) USER EQUIPMENT AND BASE STATION IN WIRELESS COMMUNICATION SYSTEM, AND METHODS PERFORMED BY THE SAME

(71) Applicant: Samsung Electronics Co., Ltd., Suwon-si (KR)

(72) Inventors: Min WU, Beijing (CN); Feifei SUN, Beijing (CN); Yi WANG, Beijing (CN); Qi XIONG, Beijing (CN); Bin YU, Beijing (CN)

(21) Appl. No.: 17/451,779

(22) Filed: Oct. 21, 2021

(30) Foreign Application Priority Data
Oct. 21, 2020 (CN) 202011131918.1
Oct. 21, 2020 (CN) 202011135416.6
Jan. 15, 2021 (CN) 202110055235.0
May 13, 2021 (CN) 202110523269.8

(51) Int. Cl. H04W 74/00; H04W 74/08; H04B 7/185

(52) U.S. Cl. CPC H04W 74/006; G01S 19/258; H04B 7/185; H04W 74/0833

(57) ABSTRACT

The present disclosure relates to a communication method and system for converging a 5^{th}-Generation (5G) communication system for supporting higher data rates beyond a 4^{th}-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. The present disclosure provides a user equipment and a base station in a wireless communication system and methods performed by the same. The method performed by the user equipment includes: determining a third timing advance based on a first timing advance configured by a base station and/or a second timing advance estimated by the user equipment, wherein the third timing advance is used for physical random access channel (PRACH) transmission of an initial random access procedure; receiving a timing advance control command indicated by the base station through a random access response (RAR); and obtaining a fourth timing advance according to a timing advance indicated by the timing advance control command and the third timing advance.

### CROSS-REFERENCE TO RELATED APPLICATIONS

This application is based on and claims priority under 35 U.S.C. § 119 to Chinese Patent Application No. 202011131918.1, filed on Oct. 21, 2020, in the Chinese Intellectual Property Office, Chinese Patent Application No. 202011135416.6, filed on Oct. 21, 2020, in the Chinese Intellectual Property Office, Chinese Patent Application No. 202110055235.0, filed on Jan. 15, 2021, in the Chinese Intellectual Property Office, Chinese Patent Application No. 202110523269.8, filed on May 13, 2021, in the Chinese Intellectual Property Office, the disclosures of which are incorporated by reference herein in their entirety.

### BACKGROUND

### 1. Field

The present disclosure relates to a field of communication technology, in particular to a user equipment and a base station in a wireless communication system and methods performed by the same.

### 2. Description of Related Art

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

### SUMMARY

In order to overcome the above technical problems or at least partially solve the above technical problems, the following technical solutions are provided:

According to an aspect of the present disclosure, there is provided a method performed by a user equipment in a wireless communication system, which may include: determining a third timing advance based on a first timing advance configured by a base station and/or a second timing advance estimated by the user equipment, wherein the third timing advance is used for physical random access channel (PRACH) transmission of an initial random access procedure; receiving a timing advance control command indicated by the base station through a random access response (RAR); and obtaining a fourth timing advance according to a timing advance indicated by the timing advance control command and the third timing advance.

According to another aspect of the present disclosure, there is provided a method performed by a base station in a wireless communication system, which may include: receiving a PRACH transmission from a user equipment, wherein the PRACH transmission is performed based on a third timing advance determined according to a first timing advance configured by the base station and/or a second timing advance estimated by the user equipment; and transmitting a timing advance control command indicated through an RAR to the user equipment, wherein a timing advance indicated by the timing advance control command and the third timing advance are used to obtain a fourth timing advance.

According to another aspect of the present disclosure, there are provided a user equipment and a base station for performing the above methods in a wireless communication system.

According to another aspect of the present disclosure, there is provided a method for channel transmission in a wireless communication network, including: determining a first time domain resource offset associated with the channel, wherein the first time domain resource offset is associated with a transmission delay; determining each of a plurality of time domain resource locations for transmitting the channel based on the first time domain resource offset; and transmitting the channel based on at least one of the plurality of time domain resource locations.

According to another aspect of the present disclosure, there is provided an apparatus for channel transmission in a wireless communication network, including: an offset determination module configured to determine a first time domain resource offset associated with the channel, wherein the first time domain resource offset is associated with a transmission delay; a location determination module configured to determine each of a plurality of time domain resource locations for transmitting the channel based on the first time domain resource offset; and a transmitting module configured to transmit the channel based on at least one of the plurality of time domain resource locations.

According to another aspect of the present disclosure, there is provided an apparatus for channel transmission in a wireless communication network, including: a transceiver configured to transmit and receive signals to and from the outside; and a processor configured to control the transceiver to perform the methods according to the embodiments of the present disclosure.

According to another aspect of the present disclosure, there is provided a computer-readable medium having stored thereon computer-readable instructions for implementing methods according to embodiments of the present disclosure when executed by a processor.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and/or additional aspects and advantages of the present disclosure will become apparent and easily understood from the following description of embodiments taken in conjunction with the accompanying drawings, in which:

FIG. 1 illustrates an example wireless network according to an embodiment of the present disclosure;

FIG. 2a illustrates example wireless transmission and reception paths according to an embodiment of the present disclosure;

FIG. 2b illustrates example wireless transmission and reception paths according to an embodiment of the present disclosure

FIG. 3a illustrates an example UE according to an embodiment of the present disclosure;

FIG. 3b illustrates an example base station gNB according to an embodiment of the present disclosure;

FIG. 4 illustrates a schematic diagram of an example timing advance in a wireless communication system;

FIG. 5 illustrates a flowchart of an example method performed by a UE in a wireless communication system according to an embodiment of the present disclosure;

FIG. 6a illustrates schematic diagrams of example common TAs indicated by a base station according to embodiments of the present disclosure;

FIG. 6b illustrates schematic diagrams of example common TAs indicated by a base station according to embodiments of the present disclosure;

FIG. 6c illustrates schematic diagrams of example common TAs indicated by a base station according to embodiments of the present disclosure;

FIG. 6d illustrates schematic diagrams of example common TAs indicated by a base station according to embodiments of the present disclosure;

FIG. 6e illustrates schematic diagrams of example common TAs indicated by a base station according to embodiments of the present disclosure;

FIG. 7 illustrates a schematic diagram of an example MAC RAR construction according to an embodiment of the present disclosure;

FIG. 8 illustrates a schematic diagram of an example TA command MAC CE construction according to an embodiment of the present disclosure;

FIG. 9 illustrates a schematic diagram of an example TA command MAC CE construction according to an embodiment of the present disclosure;

FIG. 10 illustrates a flowchart of an example method performed by a UE in a wireless communication system according to an embodiment of the present disclosure;

FIG. 11 illustrates a schematic diagram of an example timing offset according to an embodiment of the present disclosure;

FIG. 12 illustrates a block diagram of an example UE according to an embodiment of the present disclosure;

FIG. 13 illustrates a block diagram of an example base station according to an embodiment of the present disclosure;

FIG. 14 illustrates a schematic flowchart of a method for channel transmission in a wireless communication network according to an embodiment of the present disclosure;

FIG. 15 illustrates a schematic diagram of an uplink scheduling according to an embodiment of the present disclosure;

FIG. 16 illustrates a schematic diagram of expanding a value range of a timer according to an embodiment of the present disclosure;

FIG. 17 illustrates a schematic diagram of changing a start time of a timer according to an embodiment of the present disclosure;

FIG. 18 illustrates a schematic diagram in which transmission and reception for multiple HARQ processes exist according to an embodiment of the present disclosure;

FIG. 19 illustrates a schematic diagram of configuring multiple periods for channel transmission according to an embodiment of the present disclosure;

FIG. 20 illustrates a structural block diagram of an apparatus for channel transmission in a wireless communication network according to an embodiment of the present disclosure; and

FIG. 21 illustrates a schematic diagram of an apparatus for channel transmission in a wireless communication network according to an embodiment of the present disclosure.

### DETAILED DESCRIPTION

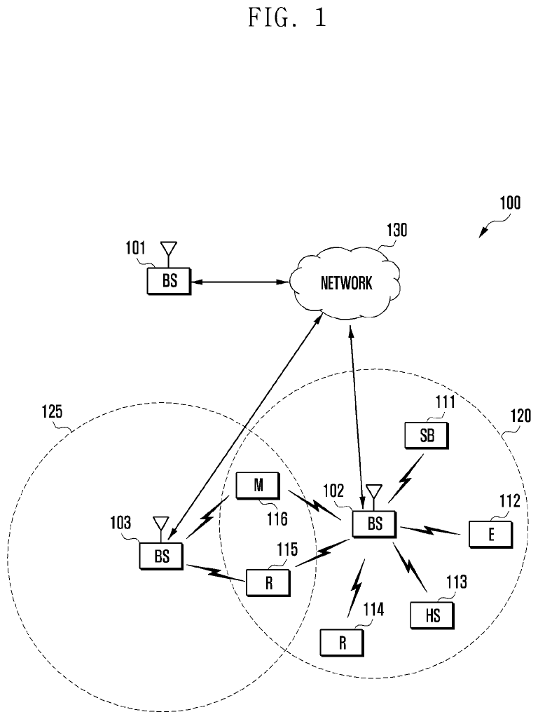

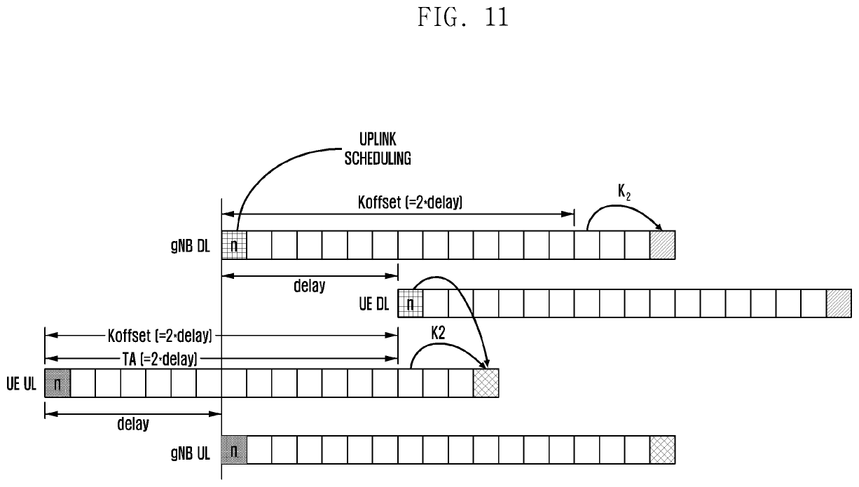

FIGS. 1 through 21, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure are described in detail below, examples of which are shown in the accompanying drawings, throughout which identical or similar reference numerals indicate identical or similar elements or elements having identical or similar functions. The embodiments described below by referring to the drawings are exemplary and are only used to explain the present disclosure, and should not be interpreted as limiting the present disclosure.

As can be understood by those skilled in the art, singular forms “a”, “an”, “said” and “the” used herein may also include plural forms unless expressly stated. It should be further understood that the phrase “including” used in the specification of the present disclosure means the presence of stated features, integers, steps, operations, elements and/or components, but does not exclude the presence or addition of one or more other features, integers, steps, operations, elements, components and/or groups thereof. It should be understood that when we say that an element is “connected” or “coupled” to another element, it may be directly connected or coupled to another element, or there may be an intermediate element. In addition, “connected” or “coupled” as used herein may include wireless connection or wireless coupling. The phrase “and/or” as used herein includes all or any unit and all combinations of one or more related listed items.

Although various elements are described using ordinal numbers such as “first”, “second”, etc., these elements are not limited herein. These terms are only used to distinguish one element from another, regardless of chronological order and importance. As used herein, the term “and/or” includes any and all combinations of one or more related listed items.

As can be understood by those skilled in the art that unless otherwise defined, all terms (including technical terms and scientific terms) used herein have the same meanings as those generally understood by those of ordinary skill in the art to which the present disclosure belongs. It should also be understood that terms such as those defined in a general dictionary should be understood to have meanings consistent with those in a context of the prior art, and will not be interpreted in idealized or overly formal meanings unless specifically defined as herein.

As can be understood by those skilled in the art, “terminal” and “terminal device” as used herein include not only a device including a wireless signal receiver with no transmitting capability, but also a device including receiving and transmitting hardware which is capable of performing bidirectional communication on a bidirectional communication link. Such devices may include a cellular or other communication device with a single-line display or a multi-line display or a cellular or other communication device without a multi-line display; a Personal Communication System (PCS), which is capable of combining voice, data processing, fax and/or data communication; a Personal Digital Assistant (PDA), which may include a radio frequency receiver, pager, internet/intranet access, web browser, notepad, calendar and/or Global Positioning System (GPS) receiver; a conventional laptop and/or palmtop or other device having and/or including a radio frequency receiver. As used herein, “terminal” and “terminal device” may be portable, transportable, installed in vehicles (aviation, sea transportation and/or land), or suitable and/or configured to run locally, and/or in a distributed form, running at any other position on the earth and/or space. As used herein, “terminal” and “terminal device” may also be a communication terminal, an internet terminal and a music/video playing terminal, such as a PDA, a Mobile Internet Device (MID) and/or a mobile phone with a music/video playing function, as well as a smart TV, a set-top box and other devices.

This description and drawings are provided as examples only to help readers understand the present disclosure. They are not intended and should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

FIG. 1 illustrates an example wireless network 100 according to an embodiment of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

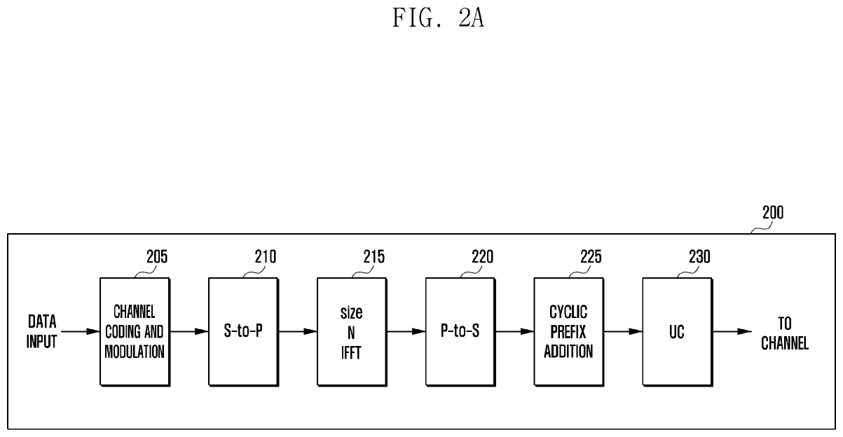

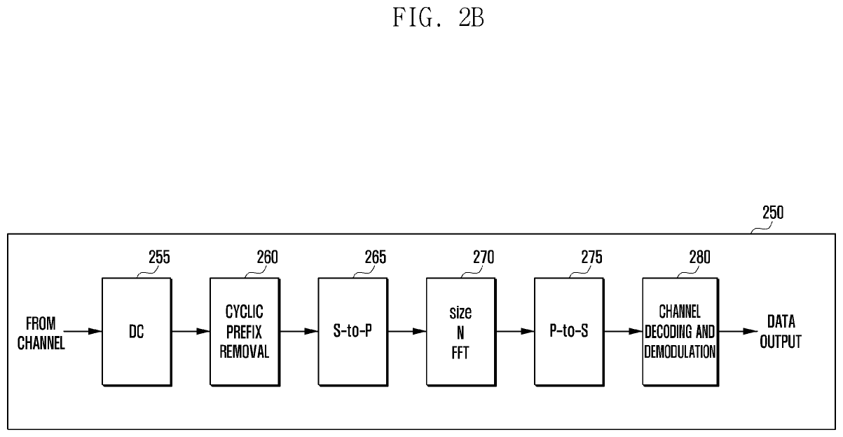

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as a UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in a gNB 102 and a UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at a UE 116 after passing through the wireless channel, and operations in reverse to those at gNB 102 are performed at a UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

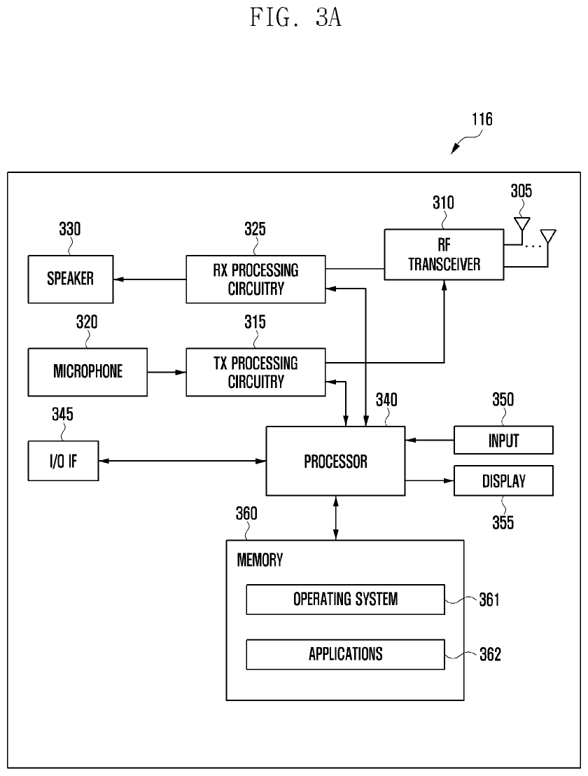

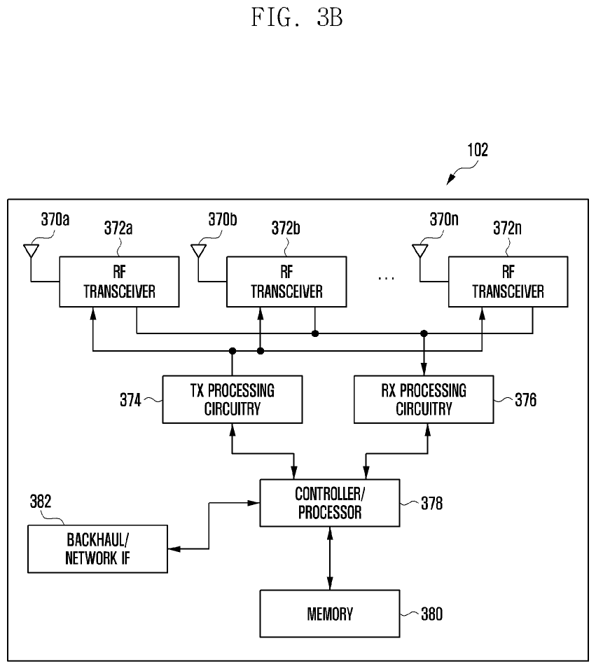

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

A UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides a UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of a UE 116 can input data into the UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

The exemplary embodiments of the present disclosure are further described below in conjunction with the accompanying drawings.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

In the 5G Rel-16 standard of 3GPP, related research on a non-terrestrial network (NTN) has been carried out. With a wide-area coverage capability of satellites, NTN may enable operators to provide 5G commercial services in areas with underdeveloped terrestrial network infrastructure and realize 5G service continuity, especially in scenarios such as emergency communication, maritime communication, aviation communication and communication along railways.

In NTN, according to whether a satellite has an ability to decode 5G signals, there may be divided into two scenarios: a transparent payload-based scenario; and a regenerative payload-based scenario. In the transparent payload-based scenario, the satellite does not have the ability to decode 5G signals, and the satellite directly transmits the received 5G signals transmitted by a terrestrial terminal to a terrestrial NTN gateway transparently. In the regenerative payload-based scenario, the satellite has the ability to decode 5G signals, and the satellite decodes the received 5G signals transmitted by the terrestrial terminal, and then re-encodes and transmits the decoded data, which may be directly transmitted to the terrestrial NTN gateway, or transmitted to other satellites, and then transferred from other satellites to the terrestrial NTN gateway.

Because the satellite is extremely high from the terrestrial (for example, height of a low-orbit satellite is 600 km or 1200 km, and height of a synchronous satellite is close to 36,000 km), a transmission delay of a communication signal between a terrestrial terminal and the satellite is extremely large, even reaching tens or hundreds of milliseconds, while in a traditional terrestrial cellular network, the transmission delay is only tens of microseconds. This huge difference makes NTN need to use different physical layer technologies from the terrestrial network, for example, physical layer technologies such as time-frequency synchronization/tracking, timing advance (TA) of uplink transmission, physical layer process, and HARQ retransmission sensitive to transmission delay are involved.

One effect of the extreme large transmission delay is that TA for a UE to transmit an uplink signal is increased. Because the TA is approximately twice the transmission delay, an existing PRACH pilot sequence for estimating the TA of up to 2 ms may not be used.

Therefore, the UE needs to adopt a new method for acquiring the TA. For example, the UE calculates a distance between the satellite and the UE according to an ephemeris of the satellite to estimate the TA; or the UE estimates the TA according to a time difference between a received timestamp and a local reference time; or the base station indicates a common TA or a reference TA through a system information block. In addition, due to the increase of TA, a scheduling delay of uplink transmission needs to be increased correspondingly, that is, an additional timing offset is introduced. The present disclosure mainly provides solutions for technical details related to TA acquisition and timing offset.

Herein, in order to simplify the description, satellites with a decoding ability, satellites without a decoding ability, air launching platforms with a decoding ability, air launching platforms without a decoding ability and other types of air transmitters in a non-terrestrial network may all be referred to as base stations. The disclosed technology is mainly used for a non-terrestrial network, but may also be used for a terrestrial network.

In order to ensure time synchronization at the base station side, both a long term evolution (LTE) system and a new radio (NR) system use an uplink timing advance (UL TA) mechanism. From the UE side, the timing advance is essentially a negative offset between a start time of a received downlink subframe and a time for transmitting an uplink subframe. By properly controlling the offset of each UE, the base station may control the arrival time of uplink signals from different UEs to the base station. For a UE far away from the base station, it is necessary to transmit uplink data ahead of a UE near the base station due to the large transmission delay.

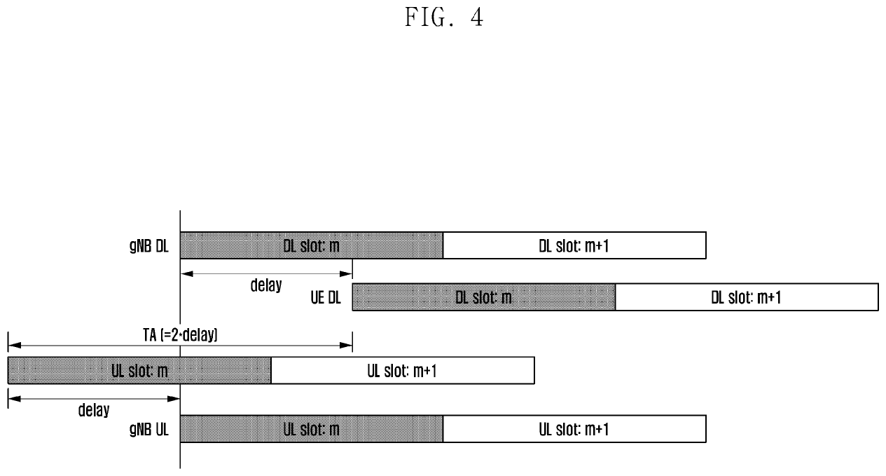

FIG. 4 illustrates a schematic diagram of a timing advance in a wireless communication system.

As shown in FIG. 4, the UE may compensate the transmission delay (delay) caused by distance through TA, and transmit a data packet in advance by the time indicated by TA, so that the uplink data packet arrives at the base station (e.g., gNB) at a desired time. It can be seen from FIG. 4 that timings of the uplink subframe and the downlink subframe on the base station side are the same, while there is an offset between timings of the uplink subframe and the downlink subframe on the UE side.

The base station may determine a TA value for each UE by measuring the uplink transmission of the UE. Therefore, as long as the UE has uplink transmission, the base station can use the uplink transmission for estimating the TA value. Theoretically, any signal transmitted by the UE (such as sounding reference signal (SRS), demodulation reference signal (DMRS), channel quality indicator (CQI), acknowledgment (ACK), negative acknowledgement (NACK), physical uplink shared channel (PUSCH), etc.) may be used to measure TA. In a random access procedure, the base station determines the TA value by measuring a received physical random access channel (PRACH) pilot, and transmits the TA to the UE through a timing advance command field of RAR, and the UE uses the received TA for subsequent uplink transmission, such as for Msg3 transmission, until an updated TA adjustment is received.

In an NTN system, because the distance between a satellite base station and a UE is much larger than the distance between a terrestrial base station and a UE in a terrestrial network (TN) system, the corresponding transmission delay and TA are also larger, and the existing PRACH pilot design is insufficient to support TA measurement in a wider range. Therefore, the UE needs to use a new method to acquire a TA. For example, the UE may estimate a TA by estimating a transmission distance/delay from the non-terrestrial base station (e.g., satellite), and/or a satellite base station indicates a TA to the UE through an SIB, then the UE may determine a TA for PRACH transmission based on the TA estimated by itself and/or the TA indicated by the satellite base station, so as to reuse existing PRACH pilots without affecting PRACH detection performance at the base station side.

According to embodiments of the present disclosure, at least the following solutions are provided:

Solution 1. A method performed by a user equipment in a wireless communication system, including:
determining a third timing advance based on a first timing advance configured by a base station and/or a second timing advance estimated by the user equipment, wherein the third timing advance is used for physical random access channel (PRACH) transmission of an initial random access procedure;
receiving a timing advance control command indicated by a base station through a random access response (RAR); and
obtaining a fourth timing advance according to a timing advance indicated by the timing advance control command and the third timing advance.

Solution 2. The method according to solution 1, further including:
updating the fourth timing advance based on timing advance drift information.

Solution 3. The method according to solution 2, further including:
determining an update period; and
updating the fourth timing advance periodically according to the update period.

Solution 4. The method according to solution 3, wherein the update period is determined by one of the following:
receiving an update period transmitted by the base station; and
obtaining an update period according to the timing advance drift information.

Solution 5. The method according to solution 2, wherein the timing advance drift information includes:
common timing advance drift information configured by the base station through a system information block (SIB), UE-specific radio resource control (RRC) signaling, or a media access control (MAC) control element (CE); and/or
user equipment-specific timing advance drift information, configured by the base station through user equipment-specific radio resource control (RRC) signaling or a media access control (MAC) control element (CE), or estimated by the user equipment.

Solution 6. The method according to solution 5, further including:
determining a first update period and a second update period;
updating the fourth timing advance according to the common timing advance drift information based on the first update period; and
updating the fourth timing advance according to the user equipment-specific timing advance drift information based on the second update period.

Solution 7. The method according to any one of solutions 1-6, further including:
receiving an absolute timing advance control command indicated by the base station through a media access control (MAC) control element (CE); and
obtaining a latest fourth timing advance according to a timing advance indicated by the received absolute timing advance control command and a latest third timing advance, wherein the latest third timing advance is determined based on a first timing advance latest configured by the base station and/or a second timing advance latest estimated by the user equipment.

Solution 8. The method according to solution 7, wherein, the indicated timing advance is determined according to a field of the absolute timing advance control command and reserved bits in the MAC CE.

Solution 9. The method according to solution 1, wherein the first timing advance is configured in one of the following ways:
configured by the base station through a system information block (SIB); and
configured by the base station through an SIB, and after the UE enters a radio resource control (RRC) connected state, the first timing advance is configured by the base station through user equipment-specific RRC signaling or a media access control (MAC) control element (CE), wherein a value configured by the user equipment-specific RRC signaling or MAC CE is used to replace a value configured by the SIB.

Solution 10. The method according to solution 9, wherein the first timing advance configured by the user equipment-specific RRC signaling or MAC CE and the first timing advance configured by the SIB have different indication granularity.

Solution 11. The method according to solution 1, 9 or 10, wherein the first timing advance is associated with a specific time, and the method further includes:
when an interval between a time for using the first timing advance and the associated specific time exceeds a preset range, the user equipment updates the first timing advance based on drift information of the first timing advance configured by the base station and uses the updated first timing advance.

Solution 12. The method according to solution 11, wherein the specific time associated with the first timing advance is indicated by the base station, or defaults to a starting location of a modification period where system information indicating the first timing advance is located, or defaults to a starting location of a radio frame with a system frame number of 0, or defaults to a time for receiving the first timing advance.

Solution 13. The method according to solution 1, wherein the first timing advance is one of the following configurations:
a cell-specific first timing advance;
a beam footprint-specific first timing advance;
a beam footprint group-specific first timing advance; and
a bandwidth part-specific first timing advance.

Solution 14. The method according to solution 1, wherein the second timing advance is estimated by one of the following estimation modes:
the second timing advance is estimated based on a geographical location difference between the user equipment and the base station;
the second timing advance is estimated based on a reference time difference between the user equipment and the base station; and
the second timing advance is estimated based on the geographical location difference and the reference time difference between the user equipment and the base station, wherein a geographical location of the base station is determined based on satellite ephemeris-related information indicated by the base station, and a reference time of the base station is indicated by the base station through an SIB.

Solution 15. The method according to solution 1, wherein whether the third timing advance includes the first timing advance configured by the base station is related to an estimation mode in which the second timing advance is estimated by the user equipment:
if the estimation mode for the second timing advance is based on the geographical location difference between the user equipment and the base station, the third timing advance includes the first timing advance; and
if the estimation mode for the second timing advance is based on the reference time difference between the user equipment and the base station, the third timing advance does not include the first timing advance.

Solution 16. The method according to solution 15, further including: the user equipment reports a user equipment capability corresponding to the estimation mode for the second timing advance to the base station.

Solution 17. The method according to solution 16, wherein the user equipment reports the estimation mode for the second timing advance to the base station in one of the following ways:
reporting the estimation mode for the second timing advance to the base station through user equipment-specific RRC signaling or a MAC CE; and
implicitly reporting the estimation mode for the second timing advance to the base station through a PRACH resource.

Solution 18. The method according to solution 1, further including: reporting the second timing advance to the base station.

Solution 19. The method according to solution 18, further including: reporting a variation of the second timing advance relative to a last reported second timing advance to the base station.

Solution 20. The method according to solution 18 or 19, wherein reporting the second timing advance to the base station is triggered by one of the following ways:
triggering the reporting of the second timing advance if an instruction of triggering the reporting of a timing advance indicated by the base station is received;
triggering the reporting of the second timing advance if a difference between the latest estimated second timing advance and the last reported second timing advance exceeds a preset range; and
triggering the reporting of the second timing advance if a timer for controlling the reporting of a timing advance expires, wherein the timer for controlling the reporting of a timing advance is started or restarted after the second timing advance is reported every time.

Solution 21. The method according to solution 20, wherein the receiving an instruction of triggering the reporting of a timing advance indicated by the base station includes one of the following:
receiving an instruction of triggering the reporting of a timing advance indicated by the base station through downlink control information (DCI); and
receiving an instruction of triggering the reporting of a timing advance indicated by the base station through a MAC CE.

Solution 22. The method according to solution 18, wherein the reporting the second timing advance to the base station includes one of the following:
reporting the second timing advance to the base station through a physical uplink control channel (PUCCH); and
reporting the second timing advance to the base station through a MAC CE.

Solution 23. The method according to solution 18, the reporting the second timing advance to the base station includes: reporting the second timing advance within a predefined or preconfigured time after a time when estimation of the second timing advance is performed.

Solution 24. The method according to solution 1, further including receiving an offset of the second timing advance from the base station to correct the second timing advance using the offset of the second timing advance.

Solution 25. According to the method of solution 24, the offset of the second timing advance is with at least one of the following configuration modes:
the offset of the second timing advance is respectively configured for different timing advance estimation modes; and
the offset of the second timing advance is configured respectively for different timing advance estimation accuracy.

Solution 26. The method according to solution 1, further including judging that the fourth timing advance is invalid when at least one of the following conditions is satisfied:
a timer configured by the base station for maintaining the timing advance expires, wherein the timer for maintaining the timing advance is started or restarted after updating the fourth timing advance every time;
a validation time for the second timing advance expires;
a beam footprint where the user equipment is located changes;
a change of a geographical location of the user equipment exceeds a preset range;
a change of distance between the user equipment and the base station exceeds a preset range; and
a time interval since the last update of the fourth timing advance exceeds a preset range.

Solution 27. The method according to solution 26, further including: when or before the fourth timing advance is invalid,
re-estimating the second timing advance, determining the third timing advance based on the latest estimated second timing advance, and using the third timing advance for uplink transmission, or initiating a random access procedure and using the third timing advance for PRACH transmission, or, adjusting the fourth timing advance judged to be invalid based on a variation between the latest estimated second timing advance and the last estimated second timing advance, and using the adjusted fourth timing advance for uplink transmission; and/or,
receiving a first timing advance latest configured by the base station, determining the third timing advance based on the first timing advance latest configured by the base station and using the third timing advance for uplink transmission, or initiating a random access procedure and using the third timing advance for PRACH transmission, or, adjusting the fourth timing advance judged to be invalid based on a variation between the latest configured first timing advance and the last configured first timing advance, and using the adjusted fourth timing advance for uplink transmission.

Solution 28. The method according to solution 1, further including:
calculating a timing offset of an uplink scheduling based on the fourth timing advance, and using the calculated timing offset to determine a delay of the uplink scheduling.

Solution 29. According to the method of solution 28, the calculating a timing offset of an uplink scheduling based on the fourth timing advance is obtained by calculating a rounding of a ratio of the fourth timing advance to a duration of one uplink slot.

Solution 30. The method according to solution 1, further including:
receiving a timing offset configured by the base station, wherein the received timing offset is calculated and obtained based on the fourth timing advance reported by the user equipment to the base station.

Solution 31. The method according to clause 30, further including:
the received timing offset is configured by the base station through an SIB, and after the UE enters an RRC connected state, is configured by the base station through UE-specific RRC signaling or MAC CE.

Solution 32. The method according to any one of solutions 1-31, wherein the method is performed by the user equipment communicating with a non-terrestrial base station in a non-terrestrial network.

Solution 33. A method performed by a base station in a wireless communication system, including:
receiving physical random access channel (PRACH) transmission of an initial random access procedure from a user equipment, wherein the PRACH transmission is transmitted based on a third timing advance determined by the user equipment based on a first timing advance configured by the base station and/or a second timing advance estimated by the user equipment; and
transmitting a timing advance control command indicated by a random access response (RAR) to the user equipment, wherein a timing advance indicated by the timing advance control command and the third timing advance are used for the user equipment to determine a fourth timing advance.

Solution 34. The method according to solution 33, further including indicating timing advance drift information to the user equipment for the user equipment to update the fourth timing advance.

Solution 35. The method according to solution 33 or 34, further including transmitting an absolute timing advance control command indicated by a media access control (MAC) control element (CE) to the user equipment, wherein, a timing advance indicated by the absolute timing advance control command and a latest third timing advance are used for the user equipment to determine a latest fourth timing advance, where the latest third timing advance is determined by the user equipment based on a first timing advance latest configured by the base station and/or a second timing advance latest estimated by the user equipment.

Solution 36. A user equipment in a wireless communication system, including:
a memory storing instructions; and
a controller configured to execute the instructions to implement the method according to any one of solutions 1 to 32.

Solution 37. A base station in a wireless communication system, including:
a memory storing instructions; and
a controller configured to execute the instructions to implement the method according to any one of solutions 33 to 35.

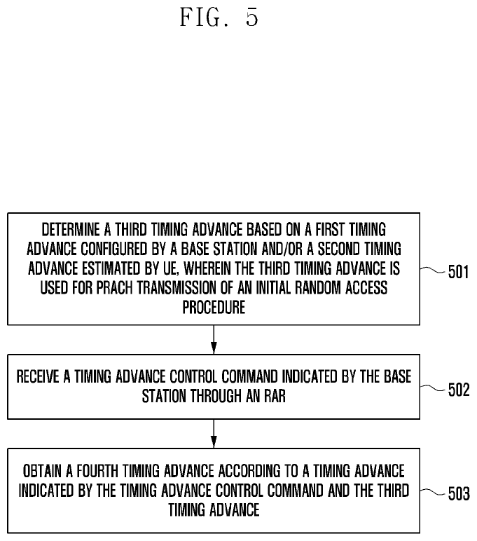

FIG. 5 illustrates a flowchart of an example method performed by a UE in a wireless communication system according to an embodiment of the present disclosure. The method may include the following steps:
S501: determining a third timing advance based on a first timing advance configured by a base station and/or a second timing advance estimated by a UE, wherein the third timing advance is used for PRACH transmission of an initial random access procedure;
S502: receiving a timing advance control command indicated by the base station through an RAR; and
S503: obtaining a fourth timing advance according to a timing advance indicated by the timing advance control command and the third timing advance.

According to an embodiment of the present disclosure, the first timing advance may be one of the following configurations:
a cell-specific first timing advance;
a beam footprint-specific first timing advance;
a beam footprint group-specific first timing advance; and
a bandwidth part-specific first timing advance.
Where, the beam footprint-specific first timing advance is a corresponding first timing advance configured for each beam footprint respectively, the beam footprint group-specific first timing advance is a corresponding first timing advance configured for each beam footprint group respectively, and the bandwidth part-specific first timing advance is a corresponding first timing advance configured for each initial uplink bandwidth part respectively.

In this description, the first timing advance (TA) may be configured by the base station through an SIB, and after the UE enters an RRC connected state, the first timing advance may also be configured by the base station through UE-specific RRC signaling or MAC CE with finer granularity. The first TA may also be referred to as a Common TA, a reference TA, or a TA offset. The first TA may be a part of a complete TA, that is, a partial TA, which cannot be directly used for uplink transmission except PRACH. The second TA is estimated by the UE based on a location or a reference time, which may also be referred to as an estimated TA. The second TA may be a part of a complete TA, that is, a partial TA, which cannot be directly used for uplink transmission except PRACH. The third TA is determined by the UE based on the first TA and/or the second TA, which may be the first TA, the second TA, or a sum of the first TA and the second TA. The third TA may also be referred to as an initial TA and may be used for PRACH transmission. The third TA may be a part of a complete TA, that is, a partial TA. The fourth TA may be determined by the UE based on a timing advance control command indicated through an RAR and the third TA, and the fourth TA may be used for uplink transmission after PRACH transmission. The fourth TA is a complete TA, which may be used for uplink transmission other than PRACH.

Methods for determining the third TA (initial TA) will be described in detail with specific embodiments below.

Embodiment 1: determination of an initial TA in an initial random access procedure.

For a UE in an RRC idle mode, in an inactive mode or just started (for example, just turned on, restarted), in the initial random access procedure, the UE may acquire an initial TA by at least one of the following ways, and use the acquired initial TA for PRACH transmission, that is, transmitting PRACH in advance by a corresponding amount of time.

Example 1-1: a UE uses a common TA indicated by the base station as an initial TA.

In the initial random access procedure, the common TA may be configured by the base station through a system information block (SIB).

For example, the base station may indicate the common TA through a broadcasted SIB and transmit the common TA to the UE, and the UE determines the initial TA for PRACH transmission based on the received common TA.

In some examples, configuration of the common TA may be Cell-specific, that is, all UEs in the same cell use the same common TA. Advantages of this solution are that signaling overhead is low, and it is suitable for a cell with a small coverage, where a difference between the maximum TA and the minimum TA within the cell may be covered by the existing PRACH, that is, the difference does not exceed 2 ms.

In some examples, configuration of the common TA may be beam footprint-specific, where the beam footprint refers to the coverage of a channel of a beam transmitted by the base station on the ground. Beam footprint-specific may also be referred to as beam-specific for short, or synchronization signal block (SSB)-specific, i.e., SSB-specific. Abeam footprint-specific common TA means that all UEs in the same beam footprint use the same common TA. The UE determines an optimal beam for downlink transmission according to SSB measurement so as to determine the common TA corresponding to the optimal beam, and the base station indicates a corresponding common TA for each beam in an SIB, that is, each common TA configured by the base station is associated with an index of an SSB. This solution is suitable for a cell with a wide coverage, where a difference between the maximum TA and the minimum TA within the cell is large and cannot be covered by the existing PRACH, but a difference between the maximum TA and the minimum TA within a beam coverage may be covered by the existing PRACH, that is, the difference does not exceed 2 ms.

In some examples, configuration of the common TA may be beam footprint group-specific, which may also be referred to as SSB group-specific, that is, all UEs in the same group of beam footprints use the same common TA, and all beams transmitted by the base station side are divided into multiple beam groups, each of the multiple beam groups contains multiple beams, the UE determines an optimal beam for downlink transmission according to SSB measurement so as to determine the beam group to which the optimal beam belongs and its corresponding common TA, and the base station indicates a corresponding common TA for each beam group in an SIB, that is, each common TA configured by the base station may be associated with an index of an SSB group. This solution is suitable for a cell with a middle coverage, where a difference between the maximum TA and the minimum TA within the cell is large and cannot be covered by the existing PRACH, but a difference between the maximum TA and the minimum TA within the coverage of several adjacent beams of the cell may be covered by the existing PRACH, that is, the difference does not exceed 2 ms.

Particularly, in the above-mentioned configuration of beam group-specific common TA, a number of beams contained in each beam group is configurable. For example, the base station may configure that each beam group contains 1, 3 or 5 beams and so on, and by default SSBs with continuous index numbers belong to the same beam group. In some implementations, in case that a total number of beams in a cell is configured to be 12 and one beam group contains 3 beams, there are 4 beam groups in total, where indexes of SSBs corresponding to the first beam group are #0, #1, #2, indexes of SSBs corresponding to the second beam group are #3, #4, #5, and so on. The base station may configure a corresponding common TA value for each beam group.

In some examples, configuration of the common TA may be bandwidth part-specific (BWP-Specific). For example, in case that a cell has multiple initial DL BWPs or multiple initial UL BWPs, each initial UL BWP has a corresponding common TA configuration, and common TAs corresponding to different initial UL BWPs may be the same or different; or, each initial DL BWP has a corresponding common TA configuration, and common TAs corresponding to different initial DL BWPs may be the same or different.

In some examples, besides being configured in one of the above ways through the SIB, the common TA may also be configured through UE-specific RRC signaling or MAC CE after the UE enters an RRC connected state, that is, configuration of the common TA may be UE-specific.

Optionally, the system supports multiple configuration modes of TA, which may be multiple of the above configuration modes, i.e., cell-specific, beam footprint-specific, beam footprint group-specific, bandwidth part-specific, and/or UE-specific. Which configuration mode is to be used may depend on the configuration of the base station.

To save signaling overhead, the granularity of the common TA above indicated by the base station may be much larger than that of a TA command. In some examples, for example, the granularity of the common TA indicated by the base station may be 1 ms, so a residual TA within 1 ms may be estimated by the existing PRACH. While the granularity of an existing TA commands is T_{c}*64*16/2^{u}, where T_{c} is a duration of a sampling interval, which is T_{c}=1/(480*10³*4096) seconds, and u is related to a Subcarrier Spacing (SCS), where u=0, 1, 2, 3 or 4 respectively correspond to SCS=15, 30, 60, 120 or 240 kHz.

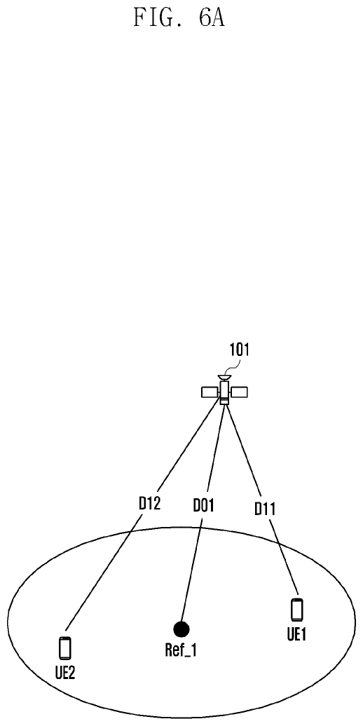

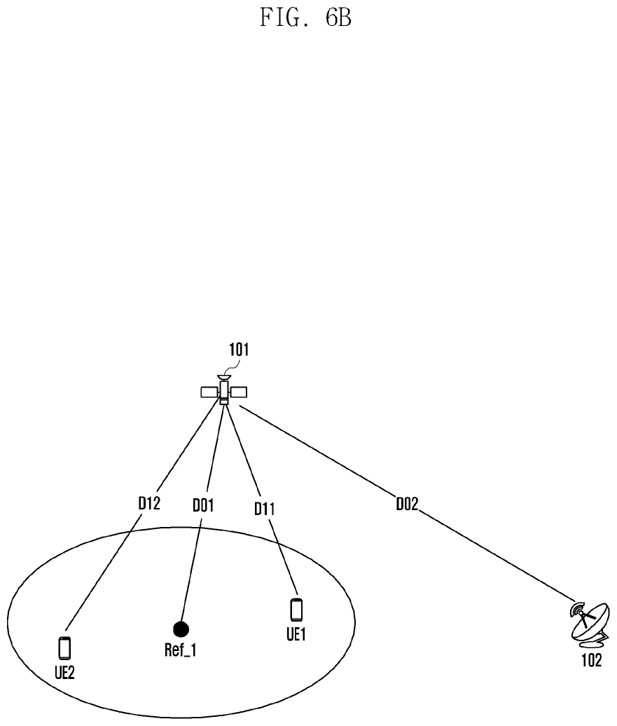

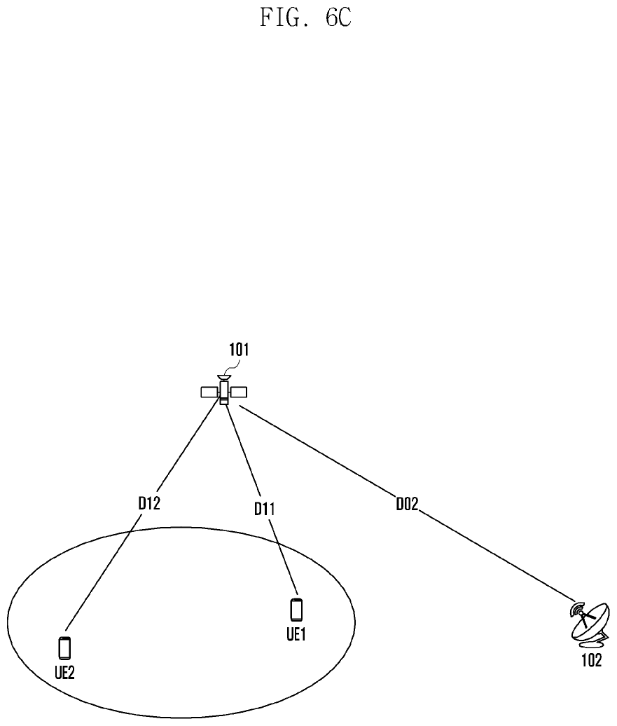

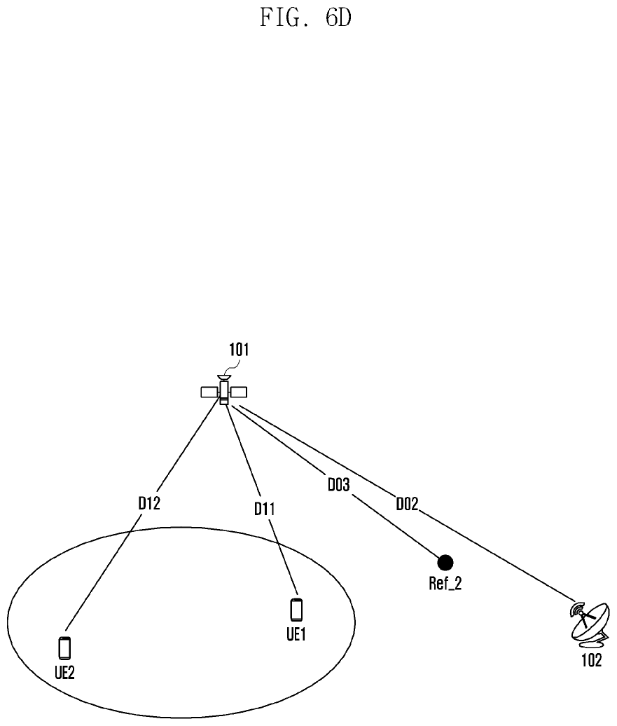

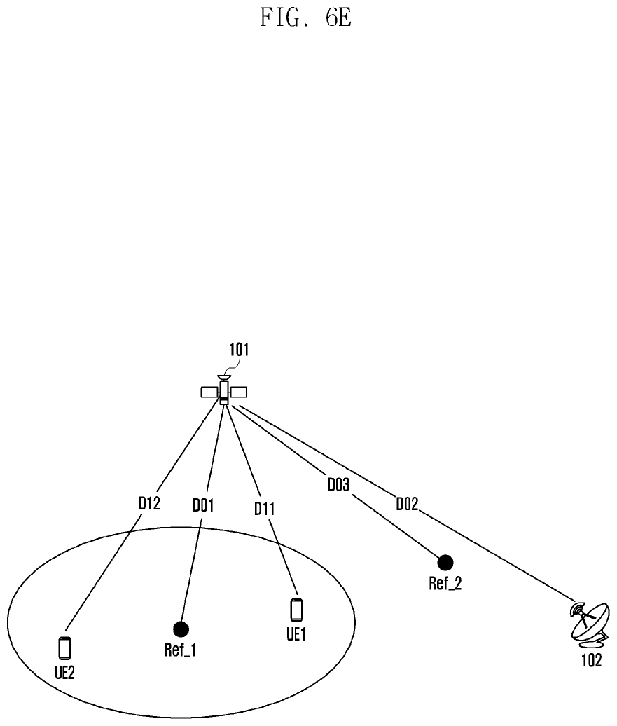

FIGS. 6a to 6e illustrate schematic diagrams of example common TAs indicated by a base station according to embodiments of the present disclosure. In FIGS. 6a-6e, D01 indicates a transmission delay between a reference point 1 Ref_1 and a satellite 101, D02 indicates a transmission delay between the satellite 101 and a terrestrial base station 102, D03 indicates a transmission delay between the satellite 101 and a reference point 2 Ref_2, D11 indicates a transmission delay between a user equipment UE1 and the satellite 101, and D12 indicates a transmission delay between a user equipment UE2 and the satellite 101.

As shown in FIG. 6a, the common TA=2×D01. The physical meaning of the common TA mentioned before is twice the transmission delay (i.e., D01) between the reference point 1 Ref_1 in a cell or beam footprint and the satellite 101. Therein, the reference point may be located at the center of the cell or beam footprint; or the reference point may be located at any location within the cell or beam footprint, or even at any location between a terrestrial UE and the satellite, and the location of the reference point depends on implementation of the satellite. The satellite here may have a decoding ability of a base station.

As shown in FIG. 6b, the common TA=2×(D01+D02). The physical meaning of the common TA mentioned before is twice the sum of the transmission delay (i.e., D01) between the reference point 1 Ref_1 in a cell or beam footprint and the satellite 101 and the transmission delay (i.e., D02) between the satellite 101 and the terrestrial base station 102. Same as above, the reference point 1 Ref_1 may be located at the center of the cell or beam footprint; or the reference point 1 Ref_1 may be located at any location within the cell or beam footprint, or even at any location between a terrestrial UE and the satellite, and the location of the reference point depends on implementation of the satellite. The satellite here may not have a base station capability of the base station, but plays a role in relaying the transmission signal between the UE and the terrestrial base station.

As shown in FIG. 6c, the common TA=2×D02. The physical meaning of the common TA mentioned before is twice the transmission delay (i.e., D02) between the satellite 101 and the terrestrial base station 102. The satellite here may not have a base station capability of the base station, but plays a role in relaying the transmission signal between the UE and the terrestrial base station.

As shown in FIG. 6d, the common TA=2×D03. The physical meaning of the common TA mentioned before is twice the transmission delay (i.e., D03) between the satellite 101 and the reference point 2 Ref_2. The reference point may be located at any location between the satellite and the terrestrial base station, depending on implementation of the satellite. The satellite here may not have a base station capability of the base station, but plays a role in relaying the transmission signal between the UE and the terrestrial base station.

As shown in FIG. 6e, the common TA=2×(D01+D03). The physical meaning of the common TA mentioned before is twice the sum of the transmission delay (i.e., D01) between the reference point 1 Ref_1 in a cell or beam footprint and the satellite 101 and the transmission delay (i.e., D03) between the satellite 101 and the reference point 2 Ref_2. Same as above, the reference point 1 Ref_1 may be located at the center of a cell or beam footprint; or the reference point 1 Ref_1 may be located at any location within the cell or beam footprint, or even at any location between the terrestrial UE and the satellite, and the location of the reference point depends on implementation of the satellite. The reference point 2 Ref_2 may be located at any location between the satellite and the terrestrial base station, depending on implementation of the satellite. The satellite here may not have a base station capability of the base station, but plays a role in relaying the transmission signal between the UE and the terrestrial base station.

Example 1-2: A UE uses its own estimated TA as an initial TA.

In an initial random access procedure, the UE may estimate a timing advance by itself and determine an initial TA for PRACH transmission based on the estimated timing advance.

According to an embodiment of the present disclosure, the UE may estimate a second timing advance using one of the following estimation modes: estimating the second timing advance based on a geographical location difference between the UE and a base station; estimating the second timing advance based on a reference time difference between the UE and the base station; and estimating the second timing advance based on the geographical location difference and the reference time difference between the UE and the base station. In some examples, a geographic location of the base station may be determined based on satellite ephemeris-related information indicated by the base station, and a reference time of the base station may be indicated by the base station through an SIB.

As used herein, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

In some examples, the UE may calculate a transmission distance between the UE and the satellite according to its own geographical location and the geographical location of the satellite, so as to obtain a corresponding transmission delay between the UE and the satellite, and the estimated TA value is twice of the transmission delay. Therein, the geographical location of the UE is determined by a global navigation satellite system (GNSS) module of the UE, that is, this solution may be applied to a UE with a GNSS capability; and the geographical location of the satellite may be determined by a satellite ephemeris indicated by the base station through an SIB.

In some examples, the UE may calculate the transmission delay between the UE and the base station based on a local reference time and a received timestamp transmitted by the base station. A time difference between the timestamp received by the UE and a time when the timestamp is received is the transmission delay, and the estimated TA value is twice of the transmission delay. Therein, the local reference time of the UE may be determined by a GNSS module, that is, this solution may be applied to a UE with a GNSS capability; and the received timestamp may be transmitted by the base station through an SIB.

According to an embodiment of the present disclosure, the UE may report a user equipment capability corresponding to an estimation mode for the second timing advance to the base station.

According to an embodiment of the present disclosure, the UE may report the estimation mode for the second timing advance to the base station in one of the following ways: reporting the estimation mode for the second timing advance to the base station through UE-specific RRC signaling or MAC CE; and implicitly reporting the estimation mode for the second timing advance to the base station through a PRACH resource.

In some examples, the system may support the above two TA estimation modes at the same time, and which TA estimation mode the UE adopts depends on the capability of the UE. The UE may report the capability corresponding to a certain TA estimation mode to the base station, that is, inform the base station whether the TA estimated by the UE is based on a satellite ephemeris or a timestamp. In addition, different UE capabilities may have different TA estimation accuracies. For example, a UE with a high positioning capability can estimate a more accurate TA, and the UE may report the capability corresponding to a certain TA estimation accuracy to the base station, that is, inform the base station of a corresponding level of the accuracy of the TA estimated by the UE. The UE may report the capability corresponding to a certain TA estimation mode and/or the capability corresponding to a certain TA estimation accuracy through RRC signaling or a MAC CE.

In some examples, in a four-step random access procedure, the UE may report the capability corresponding to a certain TA estimation mode and/or the capability corresponding to a certain TA estimation accuracy through RRC signaling or a MAC CE in Msg3; or, in a two-step random access procedure, the UE may report the capability corresponding to a certain TA estimation mode and/or the capability corresponding to a certain TA estimation accuracy through RRC signaling or a MAC CE in a PUSCH of MsgA.

In some examples, the UE may implicitly report the capability corresponding to a certain TA estimation mode and/or the capability corresponding to a certain TA estimation accuracy through the used PRACH resources, that is, UEs using different TA estimation modes use different PRACH resources, that is, the base station may know the TA estimation mode used by the UE according to the detected PRACH resources; or, UEs with different TA estimation capabilities use different PRACH resources, that is, the base station may know the TA estimation accuracy of the UE according to the detected PRACH resources.

Particularly, because the satellite moves relatively fast with respect to a terrestrial UE, a transmission distance between the satellite and the terrestrial UE may change rapidly, and a corresponding TA may also change rapidly, and if the TA is estimated too early before transmitting the PRACH, when transmitting the PRACH, the TA may be invalid. To ensure the timeliness of TA estimation, a UE may perform TA estimation no later than a certain time interval before PRACH transmission, which may be predefined or configured by the base station through an SIB.

Example 1-3: a UE determines an initial TA according to a common TA indicated by the base station and an estimated TA estimated by itself.

In an initial random access procedure, the UE may receive a common TA indicated by the base station and estimate a TA by itself, and determine an initial TA for PRACH transmission based on the common TA indicated by the base station and the estimated TA.

For example, as shown in FIGS. 6b-6e, a satellite may not have a decoding ability of a base station, but relay the transmission signal between a terrestrial base station and a UE. A transmission delay between the base station and the UE may include two parts: one part is a transmission delay between the terrestrial base station and the satellite, and the corresponding partial TA may be referred to as a common TA, and the base station may indicate the common TA through an SIB, and the specific configuration method thereof is the same as a configuration method of the initial TA described above; and the other part is a transmission delay between the UE and the satellite, and the corresponding partial TA may be referred to as a UE-specific TA, and the UE may estimate the transmission distance between the UE and the base station according to its own geographical location and the geographical location of the satellite, so as to obtain the transmission delay and then estimate the UE-specific TA. As mentioned above, the geographical location of UE may be determined by a GNSS module, and the geographical location of the satellite may be determined by a satellite ephemeris. The UE may use the sum of the common TA indicated by the base station through an SIB and the TA estimated by the UE itself for PRACH transmission.

That is, the UE may determine the initial TA, i.e., TA_initial, by the following Equation (1): TA_initial=TA_common+TA_est (1).

Where, TA_common is the common TA indicated by the base station in an SIB, and the specific configuration method thereof is the same as the configuration method of the common TA described above, that is, TA_common may be cell-specific, beam footprint-specific, beam footprint group-specific or BWP-specific; and TA_est is a TA value estimated by the UE based on the distance between the satellite and the UE. TA_initial may be used for the transmission of Msg1 (i.e., PRACH) in a four-step random access procedure or transmission of MsgA (i.e., PRACH and PUSCH) in a two-step random access procedure.

In some examples, whether the above initial timing advance TA_initial includes the common timing advance TA_common configured by the base station is related to a mode in which the UE estimates the second timing advance:
If the mode in which the UE estimates the timing advance is based on a geographical location difference between the user equipment and the base station, the initial timing advance includes the common timing advance and the estimated timing advance, that is, TA_initial=TA_common+TA_est; and
if the mode in which the UE estimates the timing advance is based on a reference time difference between the user equipment and the base station, the initial timing advance does not include the common timing advance, and only includes the estimated timing advance, that is, TA_initial=TA_est.

For example, as described with respect to FIG. 5, the above examples 1-1, 1-2, and 1-3 for determining the initial TA are used for a UE in an initial random access procedure herein, such as a UE in an RRC idle/inactive mode or just started (e.g., just turned on, restarted), after transmitting PRACH in advance by a corresponding amount of time, the UE can receive a timing advance control command (e.g., a TA command field) in the monitored RAR, and superimposes an indicated value of the received timing advance control command on the initial TA, and then uses the superimposed TA for Msg3 and all uplink transmissions thereafter until an updated TA command is received. That is, the UE may use the TA command to adjust the initial TA.

For example, the UE may determine a TA value TA_msg3 for Msg3 and uplink transmissions thereafter by the following Equation (2): TA_msg3=TA_prach+TA_cmd (2).

Where, TA_prach is the initial TA value for PRACH transmission, and TA_cmd is the indicated value of the TA command field in RAR.

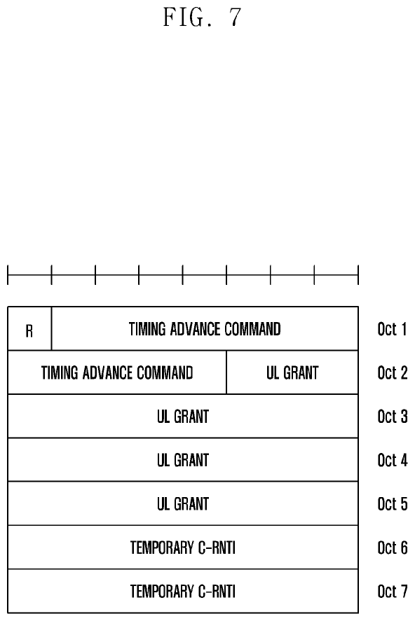

FIG. 7 illustrates a schematic diagram of a MAC RAR construction according to an embodiment of the present disclosure. The MAC RAR construction includes a timing advance command field, a UL grant field, a temporary C-RNTI field and an R field.

As shown in FIG. 7, the timing advance command indication field in RAR contains 12 bits. Optionally, the indicated value is not an Absolute TA value, but an adjustment relative to the initial TA used for PRACH transmission, and the indicated value may be either a positive number or a negative number. Optionally, the indicated value is a partial TA, which needs to be superimposed with the initial TA used for PRACH transmission, and the superimposed TA is then a complete TA, and the indicated value may only be a positive number.

According to an embodiment of the present disclosure, a TA drift (e.g., TA drift) and/or a TA control command (e.g., TA command) indicated by MAC CE may be used to maintain the TA for uplink transmission in real time.

The method for maintaining TA will be described in detail with specific embodiments below.

Embodiment 2: TA maintenance in an RRC connected state.

After the UE enters an RRC Connected Mode, the UE may maintain the TA in at least one of the following ways, and use the updated TA for uplink transmission such as PUSCH, physical uplink control channel (PUCCH), SRS, etc.

Example 2-1: a UE updates TA based on a relative TA command transmitted by a base station.

After the UE enters the RRC connected state, the base station may measure a residual TA according to uplink signal or channel transmitted by the UE, and continuously adjust the TA value through the relative TA command, so that the uplink transmission transmitted by the UE reaches the base station side at a specified time. Here, the indicated value of the TA command is an adjustment relative to the TA for the previous uplink transmission.

That is, the UE updates the TA value by the following Equation (3): TA(j+1)=TA(j)+TA_cmd (3).

Where, TA(j+1) and TA(j) are TA values used for the (j+1)-th and j-th uplink transmissions, TA_cmd is the indicated value of the relative TA command transmitted by the base station, and the (j+1)-th uplink transmission is an uplink transmission for which TA adjustment corresponding to the TA command received by the UE is performed.

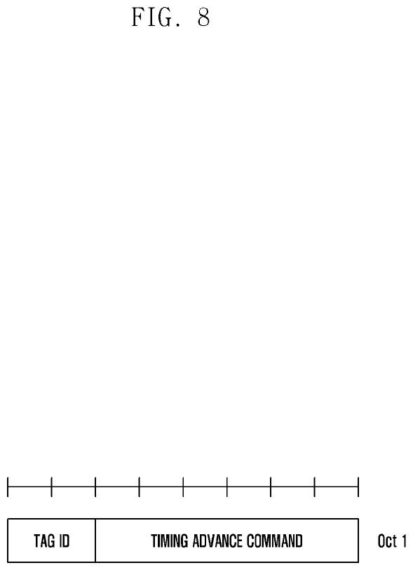

Optionally, the base station may transmit a TA command through a MAC CE to adjust TA, for example, the base station may reuse the existing TA command MAC CE, which includes a timing advance group identifier (TAG ID) field and a timing advance command field. As shown in FIG. 8, the timing advance command indication field contains 6 bits; or a MAC CE of two bytes is used to indicate a relative TA command of a larger range.

Optionally, because the satellite moves relatively fast with respect to a UE, TA changes rapidly. To ensure the timeliness of TA, the base station may dynamically indicate a TA command through downlink control information (DCI), for example, adding a new TA command indication field to the existing DCI, or reinterpreting an existing DCI indication field as the TA command, for example, reinterpreting an indication field related to HARQ-ACK feedback (such as PUCCH resource indication field, etc.) as the TA command.

Example 2-2: a UE updates TA based on an absolute TA command transmitted by a base station.

According to an embodiment of the present disclosure, the UE may receive an absolute timing advance control command indicated by a base station through a MAC CE; and obtain a latest fourth timing advance according to a timing advance indicated by the received absolute timing advance control command and a latest third timing advance, where the latest third timing advance is determined based on a first timing advance latest configured by the base station and/or a second timing advance latest estimated by the UE.

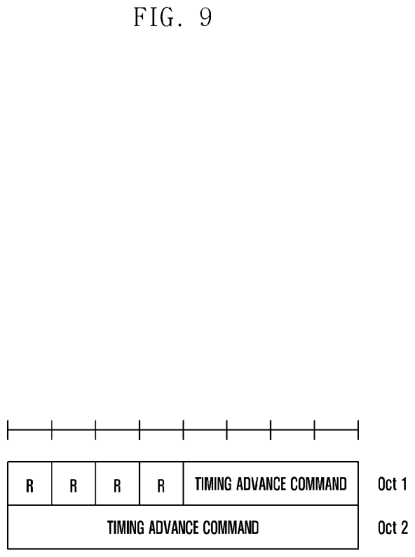

In some examples, the base station may update the TA value of a UE in an RRC connected state through an absolute TA command MAC CE. As shown in FIG. 9, the absolute TA command MAC CE includes a timing advance command field and an R field, in which the absolute TA command indication field contains 12 bits. Unlike the physical meaning of an existing absolute TA command, the indicated value of the absolute TA command herein is an adjustment relative to the initial TA, that is, the indicated value of the absolute TA command has a similar meaning to the TA command indicated in the MAC RAR, and acquisition methods for the initial TA may be referred to the above.

That is, the UE updates the TA value by the following Equation (4): TA=TA_initial+TA_cmd (4).

Where, TA_initial refers to the initial TA, for which the determination method is the same as that for a UE in an RRC idle/inactive state to determine an initial TA for PRACH transmission, that is, TA_initial=TA_common, or TA_initial=TA_est, or TA_initial=TA_common+TA_est; and TA_cmd is the indicated value of the absolute TA command MAC CE.

As mentioned above, if the initial TA is determined based on a TA estimated by the UE, for a UE in an RRC connected state, an estimated TA recently reported to the base station may be used to determine the initial TA, and a complete TA may be determined based on the initial TA and the indicated value of the absolute TA command.

According to an embodiment of the present disclosure, a common TA may be configured by the base station through an SIB, and after the UE enters an RRC connected state, the common TA is configured by the base station through UE-specific RRC signaling or MAC CE, where a value configured through the UE-specific RRC signaling or MAC CE is used to replace a value configured through the SIB.

In some examples, if the initial TA is determined based on the common TA indicated by the base station, the UE in an RRC connected state may use the common TA indicated by the base station through an SIB or the common TA indicated by the base station through the UE-specific RRC signaling or MAC CE to determine the initial TA, and determine the complete TA based on the initial TA and the indicated value of the absolute TA command. According to an embodiment of the present disclosure, the common timing advance configured through UE-specific RRC signaling or MAC CE has different indication granularity from the common timing advance configured through an SIB. For example, the common TA indicated by the base station through UE-specific RRC signaling or MAC CE may have finer granularity than the common TA indicated through an SIB. That is, before entering the RRC connected state, the UE determines the initial TA based on a coarse common TA indicated by the base station through an SIB; and after entering the RRC connected state, the UE may determine the initial TA based on a more accurate common TA indicated by the base station through UE-specific RRC signaling or MAC CE.

If the common TA is indicated by the base station through UE-specific RRC signaling, it is necessary to specify an explicit time for the UE to use the common TA after receiving a signaling indication of the common TA. For example, when the base station indicates the TA, the base station also indicates an explicit time to use the common TA, or by default, the UE starts to enable the common TA at a predefined or preconfigured interval after receiving the signaling indication of the common TA.

According to an embodiment of the present disclosure, the indicated timing advance may be determined according to a field of the absolute timing advance control command and reserved bits in the MAC CE.

In some examples, in order to expand an indication range of the absolute TA command and reuse the existing absolute TA command MAC CE as much as possible, a reserved bit “R” in the MAC CE may be used to assist in indicating the TA command. For example, the remaining three “R” bits except the first “R” bit in the MAC CE may be used to expand the bit number of the TA command indication from 12 to 15.

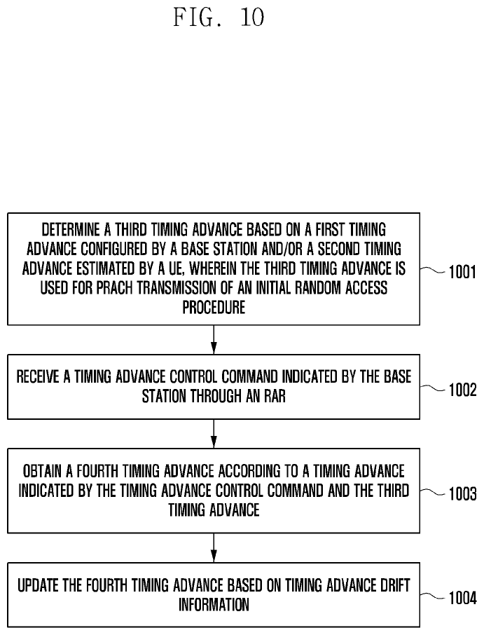

FIG. 10 illustrates a flowchart of an example method performed by a UE in a wireless communication system according to an embodiment of the present disclosure. The method may include the following steps:
S1001: determining a third timing advance based on a first timing advance configured by a base station and/or a second timing advance estimated by a UE, wherein the third timing advance is used for PRACH transmission of an initial random access procedure;
S1002: receiving a timing advance control command indicated by the base station through an RAR;
S1003: obtaining a fourth timing advance according to a timing advance indicated by the timing advance control command and the third timing advance; and
S1004: updating the fourth timing advance based on timing advance drift information.

In the embodiment shown in FIG. 10, operations of steps S1001 to S1003 are basically the same as those of steps S501 to S503 in FIG. 5, so the description thereof is omitted here for brevity.

According to an embodiment of the present disclosure, the timing advance drift information may include:
common timing advance drift information configured by the base station through an SIB, UE-specific RRC signaling, or a MAC CE; and/or
UE-specific timing advance drift information configured by the base station through UE-specific RRC signaling or MAC CE, or estimated by the UE.

The following is a detailed description with specific examples 2-3 (for updating TA based on a TA drift estimated by UE) and 2-4 (for updating TA based on a TA drift indicated by a base station).

Example 2-3: UE updates TA based on an estimated TA drift.

For example, since a moving speed of a satellite relative to a UE is relatively constant, the UE may estimate the relative moving speed through a GNSS module and a satellite ephemeris, and then estimate a distance change between the UE and the satellite within a unit time, so as to obtain a variation of a TA within a unit time, that is, a TA drift of the TA in time, and the UE may continuously update the TA based on the estimated TA drift. This method has at least the following advantages: a base station needs not to transmit a TA command frequently, thus saving a lot of signaling overhead, and also the TA may be adjusted quickly and dynamically. This method may also be used in combination with the above examples 2-1 and 2-2.

That is, the UE updates the TA value by the following Equation (5): TA(j+1)=TA(j)+TA drift*Time_delta (5).

Where, TA(j+1) and TA(j) are the (j+1)-th and j-th TA updates respectively; TA_drift is a TA drift estimated by the UE, that is, a drift of the TA within a unit time, and the unit is drift of the TA per ms, and the value of TA_drift may be positive or negative; and Time_delta is a time interval between the j-th TA update and the (j+1)-th TA update.

According to an embodiment of the present disclosure, the UE may determine an update period; and updating the fourth timing advance periodically according to the update period. For example, the UE may obtain the update period according to timing advance drift information. In some examples, the UE may periodically adjust the TA according to the estimated TA drift, and the period interval (i.e., Time_delta) may be predefined or preconfigured. For example, the period for TA adjustment may be configured by the base station through an SIB, UE-specific RRC signaling, or a MAC CE. In some examples, the base station may trigger the UE to update the TA based on the estimated TA drift. For example, the base station may trigger the UE to update the TA through DCI or a MAC CE, and the UE may enable the updated TA at a certain time interval after receiving the DCI or MAC CE, where the certain time interval may be predefined or preconfigured.

Due to the UE can only estimate the TA drift corresponding to a transmission delay between the satellite and the UE, but cannot estimate the TA drift corresponding to a transmission delay between the satellite and a terrestrial base station, this method may be applied to a scenario where the satellite has a decoding ability of the base station, that is, a complete TA may be composed of the transmission delay between the satellite and the UE, but not include the transmission delay between the satellite and the terrestrial base station.

Example 2-4: UE updates TA based on a TA drift indicated by a base station.

Example 2-4 are basically the same as example 2-3, except that the TA drift corresponding to the transmission delay between the UE and the satellite may be estimated by the base station and indicated to the UE, that is, the UE updates the TA based on a TA drift indicated by the base station.

In addition, in a scenario where the satellite does not have a decoding ability of the base station but only plays a role of signal relay, similar to a relatively constant moving speed of the satellite relative to a terrestrial UE, the satellite also has a relatively constant moving speed relative to a terrestrial base station, thus there is also a TA drift corresponding to a transmission delay between the satellite and the terrestrial base station. For convenience of description, in embodiments of the present disclosure, the TA drift corresponding to the transmission delay between the UE and the satellite may be referred to as a UE-specific timing advance drift (i.e., UE-specific TA drift), while the TA drift corresponding to the transmission delay between the satellite and the terrestrial base station may be referred to as a common timing advance drift (i.e., common TA drift). The UE-specific TA drift may be configured to the UE by the base station or estimated by the UE, while the common TA drift may be configured to the UE by the base station.

The UE may update the TA according to the common TA drift indicated by the base station, and the UE-specific TA drift indicated by the base station or estimated by the UE.

For example, the UE may adjust the TA according to the following Equation (6): TA(j+1)=TA(j)+(TA_common_drift+TA_uespecific_drift)*Time_delta (6).

Or,

The UE may adjust the TA according to the following Equations (7)-(8) respectively:
TA(j+1)=TA(j)+TA_common_drift*Time_delta (7), and
TA(j+1)=TA(j)+TA_uespecific_drift*Time_delta (8).

Where, TA(j+1) and TA(j) are the (j+1)-th and j-th TA updates respectively, TA_common drift is the TA drift corresponding to the transmission delay between the UE and the satellite, TA_uespecific_drift is the TA drift corresponding to the transmission delay between the satellite and the terrestrial base station, and Time_delta is a time interval between the j-th TA update and the (j+1)-th TA update.

According to an embodiment of the present disclosure, the UE may determine an update period; and updating the fourth timing advance periodically according to the update period. For example, the UE may receive an update period transmitted by the base station to determine the update period. According to an embodiment of the present disclosure, the UE may determine a first update period and a second update period, and update the fourth timing advance according to common timing advance drift information based on the first update period, and update the fourth timing advance according to UE-specific timing advance drift information based on the second update period.

In some examples, an adjustment period for a common TA drift may be different from that for a UE-specific TA drift. For example, the base station may configure corresponding adjustment periods for common TA drift and UE-specific TA drift respectively. That is, the UE may adjust the TA at different times respectively based on the common TA drift or the UE-specific TA drift, instead of having to adjust the TA at the same time.

In some examples, the base station may configure the UE-specific TA drift and the common TA drift to the UE respectively. For example, the base station may configure the UE-specific TA drift through UE-specific RRC signaling or MAC CE, and configure the common TA drift through an SIB. Similar to the common TA mentioned above, the common TA drift may be cell-specific, beam-specific, beam group-specific or bandwidth part-specific. Alternatively, the base station may respectively configure the UE-specific TA drift and the common TA drift through UE-specific RRC signaling or MAC CE. Alternatively, the base station may respectively configure the UE-specific TA drift and the common TA drift through an SIB, in which the common TA drift may be cell-specific, beam-specific, beam group-specific or bandwidth part-specific.

In some examples, the base station configures the sum of the UE-specific TA drift and the common TA drift to the UE, that is, the UE needs not to distinguish between the UE-specific TA drift and the common TA drift, and just updates the TA according to the TA drift configured by the base station. Same as above, the base station may configure the sum of the UE-specific TA drift and the common TA drift through UE-specific RRC signaling, a MAC CE or an SIB.

In some examples, the base station may configure the common TA drift to the UE, while the UE-specific TA drift is estimated by the UE itself. Therein, the base station may configure the common TA drift through UE-specific RRC signaling, a MAC CE or an SIB.

In some examples, the UE periodically updates the TA according to the TA DriftDrift configured by the base station and/or the TADriftDrift estimated by the UE, and a period (time interval) for updating the TA may be predefined, preconfigured or predetermined, for example, the period for adjusting the TA may be configured by the base station through an SIB or UE-specific RRC signaling; or, the period for updating the TA may be calculated by the UE based on the TA drift, and the period for updating the TA may be a time interval that enables the TA drift to reach a preset size.

In some examples, the UE needs to update the TA based on the TA drift for each uplink slot, and use the updated TA for uplink transmission. In other words, the period (time interval) for updating the TA is one uplink slot.

In some examples, the base station may trigger the UE to update the TA based on the TA drift configured by the base station and/or the TA drift estimated by the UE. For example, the base station may trigger the UE to update the TA through DCI or a MAC CE, and the UE may enable the updated TA at a certain time interval after receiving the DCI or MAC CE, where the certain time interval may be predefined or preconfigured.

As mentioned above, the base station may indicate the common TA through an SIB. Since the common TA is continuously changing, the base station needs to indicate the latest common TA continuously. However, considering that a change time of system information is limited by a minimum modification period, the common TA indicated through an SIB may not be applicable to a whole modification period. When the UE determines an initial TA based on the common TA indicated by the SIB, the UE further needs to adjust the common TA indicated by the SIB. Similar to a TA adjustment in an RRC connected state, the adjustment may also be based on the drift of the common TA.

According to an embodiment of the present disclosure, the common timing advance may be associated with a specific time. When an interval between a time when the common timing advance is used and the associated specific time exceeds a preset range, the UE may update the common timing advance based on drift information of the common timing advance configured by the base station and use the updated common timing advance.

According to an embodiment of the present disclosure, the specific time associated with the common timing advance may be indicated by the base station, or default to a starting location of a modification period where system information indicating the common timing advance is located, or default to a starting location of a radio frame with a system frame number of 0, or default to a time for receiving the common timing advance.

In some examples, the common TA indicated by the base station through an SIB is associated with an absolute time. If an interval between a time when the UE applies the common TA and the associated time exceeds a predefined or preconfigured range, the UE needs to adjust the common TA, for example, the common TA may be adjusted based on a TA_drift indicated by the base station. When the base station indicates the common TA through an SIB, the base station may indicate a corresponding TA_drift together.

For a UE in an RRC connected mode, when initiating some certain random access procedure, the same TA may be used for transmitting PRACH and transmitting other uplink physical channels/signals, for example, when the initiated random access procedure is non-contention-based; while for other certain random access procedure, different TAs may be used for transmitting PRACH and transmitting other uplink physical channels/signals, for example, when the initiated random access procedure is contention-based, a TA determination method for this case may be a method for determining an initial TA for PRACH transmission for a UE in an RRC idle/inactive state mentioned before.

According to the method for determining the initial TA mentioned above, a common TA used in determining the initial TA for PRACH transmission based on the common TA by a UE in an RRC connected state may be different from that by a UE in an RRC idle/inactive. The UE in an RRC connected state may determine the initial TA based on a UE-specific common TA, that is, a common TA configured by the base station through UE-specific RRC signaling or MAC CE; while the UE in an RRC idle/inactive state may only determine the initial TA based on a cell-specific, beam-specific, beam group-specific or bandwidth part-specific common TA, that is, a common TA configured by the base station through an SIB.

In some examples, which common TA the UE in an RRC connected state uses to determine the initial TA for PRACH transmission may be determined by the type of a random access procedure initiated by the UE. For example, when the purpose of initiating the random access procedure is to correct the asynchronization, the common TA configured through an SIB may be used to determine the initial TA for PRACH transmission; and when the purpose of initiating the random access procedure is to request uplink resources, the common TA configured through UE-specific signaling may be used to determine the initial TA for PRACH transmission.

Embodiment 3: reporting of TA estimation.

According to an embodiment of the present disclosure, a UE may report a second timing advance estimated by the UE to a base station.

Among the above methods for determining and updating a TA, it is one important method that the UE estimates a TA according to location information or a reference time. In order to make the base station have complete knowledge of a TA compensated by the UE side, the UE may report the estimated TA to the base station, for the purpose that the base station may configure a timing offset for uplink transmission based on the TA compensated by the UE side, in which the timing offset is used to determine transmission slot of uplink transmission. Specifically, on the basis of a scheduling delay indicated in DCI (such as the scheduling delay K2 of PUSCH, the scheduling delay K1 of PUCCH, etc.), the time offset is additionally superimposed to determine the number of a slot for uplink transmission. TA granularity reported by the UE to the base station may be the same as an existing TA granularity configured by the base station to the UE, that is, T_{c}*64*16/2^{u}, where T_{c} is a duration of a sampling interval, which is T_{c}=1/(480*10³*4096) seconds, and u is related to a subcarrier spacing (SCS), where u=0, 1, 2, 3 or 4 respectively correspond to SCS=15, 30, 60, 120 or 240 kHz.

In some examples, in a four-step random access procedure, the UE may transmit PRACH based on the estimated TA, and always report the estimated TA or TA for PRACH compensation to the base station through a MAC CE or RRC signaling in Msg3.

In some examples, in the four-step random access procedure, the UE may transmit PRACH based on the estimated TA, and whether to report the estimated TA or TA for PRACH compensation in Msg3 may be configured by the base station through an SIB; or, whether to report the estimated TA or TA for PRACH compensation in Msg3 may be indicated by the base station in RAR.

In some examples, in a two-step random access procedure, the UE may transmit MsgA based on the estimated TA, and report the estimated TA or TA for MsgA compensation to the base station through a MAC CE or RRC signaling in a PUSCH of MsgA.

In some examples, in the two-step random access procedure, the UE may transmit MsgA based on the estimated TA, and whether to report the estimated TA or TA for MsgA compensation in the PUSCH of MsgA may be configured by the base station through an SIB.

In some examples, after the UE enters an RRC connected state, the base station may trigger the UE to report the estimated TA or the compensated total TA value through explicit signaling. The base station triggers TA reporting through a MAC CE, and correspondingly, the UE reports the TA through a MAC CE. For example, the base station triggers TA reporting through reserved bits in an existing MAC CE for indicating a TA command, reserved bits in an existing MAC CE for indicating an absolute TA value, or a newly defined dedicated MAC CE. Alternatively, the base station triggers TA reporting through DCI, and correspondingly, the UE reports the TA through a PUCCH. For example, the base station triggers TA reporting through a newly added 1 bit in DCI, by reinterpretation of an existing bit field in DCI, or an existing reserved bit or reserved state in DCI.

According to an embodiment of the present disclosure, reporting the second timing advance to the base station may be triggered by one of the following ways:
triggering the reporting of the second timing advance if an instruction of triggering the reporting of a timing advance indicated by the base station is received;
triggering the reporting of the second timing advance if a difference between the latest estimated second timing advance and the last reported second timing advance exceeds a preset range; and
triggering the reporting of the second timing advance if a timer for controlling the reporting of a timing advance expires, wherein the timer for controlling the reporting of a timing advance is started or restarted after the second timing advance is reported every time.

According to an embodiment of the present disclosure, receiving an instruction of triggering the reporting of a timing advance indicated by the base station may include one of the following:
receiving an instruction of triggering the reporting of a timing advance indicated by the base station through DCI; and
receiving an instruction of triggering the reporting of a timing advance indicated by the base station through a MAC CE.

In some examples, after entering an RRC connected state, the UE reports the estimated TA to the base station through a MAC CE or RRC signaling, and the UE needs to report each estimated TA, and in order to ensure the timeliness of the estimated TA, the UE needs to report the estimated TA to the base station within a predefined or preconfigured time after estimating the TA.

In some examples, after entering the RRC connected state, the UE may trigger TA reporting based on a predefined event. For example, if a difference between a TA latest estimated by the UE and the estimated TA reported to the base station before exceeds a predefined or preconfigured threshold, the UE triggers TA reporting.

In some examples, after entering the RRC connected state, the UE may trigger TA reporting based on a preconfigured timer. For example, the base station configures a TA_Reporting_Timer for the UE through RRC signaling, and the UE starts or restarts TA_Reporting_Timer (timing advance reporting timer) after reporting the estimated TA every time. During the running of TA_Reporting_Timer, the UE does not need to initiate TA estimation and reporting; and after TA_Reporting_Timer expires, the UE may initiate TA estimation and reporting.

According to an embodiment of the present disclosure, the UE may report a variation of the second timing advance relative to a last reported second timing advance to the base station.

In some examples, in order to save the signaling overhead of reporting TA estimation, the UE may report a variation relative to a last reported TA estimation, that is, the UE needs not to report a complete TA estimation value. However, when the UE reports TA estimation for the first time, the UE needs to report a complete TA estimation value, and specifically, all the methods mentioned above may be used. The base station may also trigger the UE to report a variation of TA estimation and a complete TA estimation value through different signaling respectively.

According to an embodiment of the present disclosure, the UE reporting the second timing advance to the base station may include one of the following:
reporting the second timing advance to the base station through a PUCCH; and
reporting the second timing advance to the base station through a MAC CE.

According to an embodiment of the present disclosure, the UE may report the second timing advance within a predefined or preconfigured time after a time when estimation of the second timing advance is performed.

Both TA estimation and TA reporting need to consume power of the UE, and in order to reduce power consumption of the UE as much as possible, the number of TA estimation and reporting may be limited, especially for an Internet of Things (IoT) UE which has a high requirement for power consumption.

In some examples, the UE estimates TA and transmits Msg1 (four-step random access procedure) or MsgA (two-step random access procedure) with the estimated TA as the initial TA only when initiating random access in an RRC disconnected state, and reports the estimated TA only during the random access procedure, purpose of which is to establish an RRC connection. For a four-step random access procedure, the UE transmits PRACH based on the estimated TA and reports the estimated TA to the base station in Msg3; and for a two-step random access procedure, the UE transmits MsgA based on the estimated TA, that is, the UE transmits PRACH and associated PUSCH based on the estimated TA, and reports the estimated TA to the base station in PUSCH of MsgA. For example, the UE may report the estimated TA in PUSCH of Msg3 or MsgA through a dedicated MAC CE.

After entering an RRC connected state, a UE may no longer estimate TA, and even if uplink asynchronization occurs (i.e., TA is invalid), the UE may still transmit random access triggered for uplink asynchronization based on a TA estimated when establishing the RRC connection, that is, the UE transmits Msg1 or MsgA based on the previously estimated TA, and needs not to report the reported estimated TA again. Since the network cannot identify whether the random access procedure initiated by the UE is triggered for uplink asynchronization, all the random access procedures of the UE after entering the RRC connected state may be based on the TA estimated when establishing the RRC connection. That is, the UE estimates TA only once when establishing the RRC connection and reports TA only once during the RRC connection establishment, and no longer estimates TA and reports TA after entering an RRC connected state.

From the perspective of the base station, the base station may judge whether the purpose of a random access procedure is to establish an RRC connection according to whether an estimated TA reported by the UE is received in the random access procedure. If an estimated TA reported by the UE is received, the purpose of the random access procedure is to establish an RRC connection, and Msg1 or MsgA of the random access procedure is transmitted based on the received estimated TA; and if an estimated TA reported by the UE is not received, the random access procedure is initiated in an RRC connected state, the base station has already received an estimated TA reported by the UE in the RRC establishment process, and Msg1 or MsgA of the random access procedure is transmitted based on an estimated TA reported before. That is, the base station may store the estimated TA reported by the UE in the RRC establishment process.

In some examples, the UE estimates TA and transmits Msg1 or MsgA with the estimated TA as the initial TA when initiating random access in an RRC disconnected state, and reports the estimated TA during the random access procedure. As mentioned above, the UE may report the estimated TA in Msg3 (four-Step random access procedure) or PUSCH of MsgA (two-step random access procedure). After entering an RRC connected state, the UE may estimate TA and report TA when a certain condition is satisfied. For example, the UE may estimate TA and report TA when one of the following conditions is satisfied:

Condition 1: after entering an RRC connected state, a UE re-estimates TA only when uplink asynchronization occurs (i.e., TA is invalid), transmits Msg1 or MsgA based on the re-estimated TA, and reports the latest estimated TA to the base station in a random access procedure triggered for asynchronization. The UE may not estimate TA and report TA under other circumstances. For a random access procedure triggered for other reasons in an RRC connected state, since the TA is still valid, the UE may transmit Msg1 or MsgA based on the valid TA.

Condition 2: after entering an RRC connected state, a UE reevaluates TA only when uplink asynchronization occurs (i.e., TA is invalid) and when a time from the last estimation of TA exceeds a preset range, transmits Msg1 or MsgA based on the re-estimated TA, and reports the latest estimated TA to the base station in a random access procedure triggered for asynchronization. The UE may not estimate TA and report TA under other circumstances. For a random access procedure triggered for other reasons in an RRC connected state, since the TA is still valid, the UE may transmit Msg1 or MsgA based on the valid TA. If the random access procedure is triggered for asynchronization, and the time from the last estimation of TA does not exceed the preset range, the UE may transmit Msg1 or MsgA based on the last estimated TA. The preset range in judging whether the time from the last estimation of TA exceeds the preset range may be predefined or preconfigured.

Condition 3: After entering an RRC connected state, a UE re-estimates TA only when initiating random access, transmits Msg1 or MsgA based on the re-estimated TA, and reports the latest estimated TA to the base station in the random access procedure, regardless of whether the random access is triggered for asynchronization. The UE may not estimate TA and report TA under other circumstances.

Embodiment 4: TA offset.

According to an embodiment of the present disclosure, a UE may receive an offset of a second timing advance from a base station to correct the second timing advance using the offset of the second timing advance.

In a method of determining TA by a UE estimating, there is a certain offset between a TA estimated by the UE and an actual TA, that is, TA offset, which may also be referred to as TA margin. For example, a reference time of the UE and a reference time of the base station may come from different time synchronization sources, and there is a fixed time difference between them, then that the UE estimates TA based on timestamps would create a TA offset/margin; and/or a satellite location estimated by the UE according to a reference time and a satellite ephemeris may also have a certain offset, that is, that the UE estimates TA based on a distance between the satellite and the UE would also create a TA offset/margin. In order to control an error between the TA estimated by the UE and the actual TA within a certain range, the base station may indicate a TA offset/margin to the UE, and the UE superimposes the TA offset/margin indicated by the base station on the TA estimated by itself (i.e., TA_offset/margin+TA_est) to reduce an estimation error. In the above-mentioned method for determining an initial TA by the UE in an RRC idle/inactive state and the method for updating TA by UE in an RRC connected state, if the UE determines TA according to an estimated TA, the TA_offset/margin indicated by the base station can be superimposed on the estimated TA.

In some examples, the base station configures the above TA offset/margin through an SIB, that is, UEs in one cell may use the same TA offset/margin; or the base station configures the above TA offset/margin through UE-specific RRC signaling or MAC CE, that is, each UE has its own TA offset/margin.

According to an embodiment of the present disclosure, the offset of the second timing advance may be with at least one of the following configuration modes:
the offset of the second timing advance is respectively configured for different timing advance estimation modes; and
the offset of the second timing advance is configured respectively for different timing advance estimation accuracy.

In some examples, the configuration of TA offset/margin is related to the estimation mode for the TA and/or the TA estimation accuracy of the UE. For example, the base station configures corresponding TA offsets/margins according to different TA estimation modes (based on satellite ephemeris or based on timestamp) respectively, and/or configures corresponding TA offsets/margins according to different TA estimation accuracies respectively.

Embodiment 5: Validation of TA.

After acquiring a TA by the above methods, a UE may maintain the TA based on a predefined mechanism. That is, the UE judges whether the TA is valid according to a predefined rule, and if the TA is judged to be valid, the TA can be continuously used for transmitting uplink physical signal/channel, and if the TA is judged to be invalid, the TA needs to be updated or re-acquired.

According to an embodiment of the present disclosure, when at least one of the following conditions is satisfied, a fourth timing advance may be judged to be invalid:
a timer configured by a base station for maintaining the timing advance expires, wherein the timer for maintaining the timing advance is started or restarted after updating the fourth timing advance every time;
a validation time for a second timing advance expires;
a beam footprint where the UE is located changes;
a change of a geographical location of the UE exceeds a preset range;
a change of distance between the UE and the base station exceeds a preset range; and
a time interval since the last update of the fourth timing advance exceeds a preset range.

For example, the UE may judge that the TA is invalid through at least one of the following events:
If a timer (TimeAlignmentTimer (a time alignment timer)) configured by the base station for maintaining the TA expires, the UE judges that the TA is invalid. Here, the UE starts or restarts the TimeAlignmentTimer every time the TA is updated;
If a beam of the downlink transmission of the UE changes, the UE judges that the TA is invalid;
If a change of the geographical location of the UE exceeds a predefined or preconfigured threshold, the UE judges that the TA is invalid. Here, the UE needs to periodically estimate its own geographical location based on a GNSS module;
If a change of distance between the UE and the satellite exceeds a predefined or preconfigured threshold, the UE judges that the TA is invalid. Here, the UE needs to periodically estimate the distance between itself and the satellite based on a GNSS module and a satellite ephemeris;
If the UE calculates that the TA drift after the last update of the TA exceeds a predefined or preconfigured threshold according to a TA drift configured by the base station or estimated by itself, the UE judges that the TA is invalid;
If a time interval since the last update of the TA exceeds a predefined or preconfigured threshold, the UE judges that the TA is invalid; or
If a Validation Time or Validation Timer configured by the base station for estimating the TA expires, the UE judges that the TA is invalid. Here, the UE starts the Validation Time or Validation Timer after estimating TA every time.

According to an embodiment of the present disclosure, when or before the fourth timing advance is invalid, the UE may perform the following operations:
re-estimating the second timing advance, determining the third timing advance based on the latest estimated second timing advance, and using the third timing advance for uplink transmission, or initiating a random access procedure and using the third timing advance for PRACH transmission, or, adjusting the fourth timing advance judged to be invalid based on a variation between the latest estimated second timing advance and the last estimated second timing advance, and using the adjusted fourth timing advance for uplink transmission; and/or,
receiving a first timing advance latest configured by the base station, determining the third timing advance based on the first timing advance latest configured by the base station and using the third timing advance for uplink transmission, or initiating a random access procedure and using the third timing advance for PRACH transmission, or, adjusting the fourth timing advance judged to be invalid based on a variation between the latest configured first timing advance and the last configured first timing advance, and using the adjusted fourth timing advance for uplink transmission.

If the TA is judged to be invalid in the above events, the UE needs to perform at least one of the following processes:
the UE needs to re-initiate a random access procedure to acquire the TA, which is similar to a UE in an RRC idle/inactive state initiating a random access procedure mentioned above, and needs to acquire an initial TA for PRACH transmission. The UE may determine the initial TA based on a re-estimated TA and/or a common TA latest indicated by the base station. Unlike a UE in an RRC idle/inactive state, the UE may determine the initial TA based on a common TA configured by the base station through UE-specific RRC signaling or MAC CE;
the UE needs to update the TA based on the TA drift mentioned above;
the UE needs to re-estimate a TA and/or receive a common TA latest indicated by the base station, and determine the initial TA based on the re-estimated TA and/or the common latest TA indicated by the base station. Unlike a UE in an RRC idle/inactive state, the UE may determine the initial TA by using a common TA configured through UE-specific RRC signaling or MAC CE, and directly use the initial TA for uplink transmission; and
the UE needs to re-estimate a TA and/or receive a common TA latest indicated by the base station, adjust a timing advance judged to be invalid based on a variation between the latest estimated timing advance and the last estimated timing advance, and/or adjust the timing advance judged to be invalid based on a variation between the latest configured public timing advance and the last configured public timing advance, and use the adjusted timing advance for uplink transmission.

In some examples, in order not to affect the uplink transmission, the UE estimates a TA and/or receives a common TA latest indicated by the base station in advance before the TA is expected to be invalid, so as to ensure the continuity of TA usage, that is, ensure that there is no gap period in which the TA is invalid so that no uplink transmission can be transmitted during the gap period except PRACH. For example, the UE re-estimates a TA and/or receives a common TA latest indicated by the base station before a beam switching occurs; or, the UE re-estimates a TA and/or receives a common TA latest indicated by the base station before the validation time of the estimated TA expires; or, the UE re-estimates a TA and/or receives a common TA latest indicated by the base station before a change of the geographical location is expected to exceed a certain range.

Embodiment 6: timing offset.

According to an embodiment of the present disclosure, the UE may calculate a timing offset of an uplink scheduling based on a fourth timing advance, and use the calculated timing offset to determine a delay of the uplink scheduling.

In an LTE system, considering a decoding time of PDCCH and a transmitting preparation time of PUSCH/PUCCH, there is a fixed time interval between PDCCH and its scheduled PUSCH/PUCCH. In an NR system, in addition to considering the decoding time of PDCCH and the transmitting preparation time of PUSCH/PUCCH, in order to allocate resources within a period of time to a plurality of UEs at a certain time point for improving scheduling efficiency, a base station may dynamically indicate the uplink scheduling delay (such as the scheduling delay K2 of PUSCH and the scheduling delay K1 of PUCCH) through DCI. In an NTN system, due to an increase of transmission delay, a TA for uplink transmission increases, so it is necessary to add a timing offset, which is related to a TA value compensated by a UE side, to the existing K2 and K1 values to determine a slot number of uplink transmission. As shown in FIG. 7, the timing offset is basically equal to a TA value compensated by the UE side, and there is a certain time interval between an uplink slot scheduled by the UE and a downlink slot scheduled by an indication, and the time interval is approximately equal to twice of the transmission delay, that is, approximately equal to the TA. However, for the granularities of the timing offset and TA, the granularity (i.e., unit) of timing offset is a number of slots, while the granularity (i.e., unit) of TA adjustment is T_{c}*64*16/2^{u}.

According to an embodiment of the present disclosure, the UE calculating a timing offset of an uplink scheduling based on the fourth timing advance may be obtained by calculating a rounding of a ratio of the fourth timing advance to a duration of one uplink slot.

In some examples, the UE may derive timing offsets for various timing relationships based on a compensated total TA value. For example, the UE obtains a timing offset from a TA value according to the following Equation (9): T_Offset=└T_{TA}/Tₛₗₒₜ^{u}┘ (9).

Where, T_{TA} is a time corresponding to the total TA value compensated by a UE side, unit of which is millisecond, and Tₛₗₒₜ^{u} slot is the time contained in one slot, size of which is related to a subcarrier spacing. For example, when SCS=15, 30, 60, 120, or 240 KHZ, that is, when u=0, 1, 2, 3, or 4, Tₛₗₒₜ^{u}=1, ½, ¼, ⅛, and 16 ms correspondingly. That is, the UE converts a compensated total TA time into a corresponding number of slots by rounding down, to serve as the timing offset, that is, unit of the timing offset is uplink slot.

In some examples, in a four-step random access procedure, the UE reports an estimated TA in Msg3, so a timing offset of PUCCH carrying ACK feedback corresponding to Msg4 may be calculated from the TA reported by the UE, instead of a timing offset broadcast by SIB; and in a two-step random access procedure, the UE reports an estimated TA in PUSCH of MsgA, so a timing offset of PUSCH carrying ACK feedback corresponding to MsgB may be calculated from the TA reported by the UE, instead of a timing offset broadcast by SIB.

According to an embodiment of the present disclosure, a UE may receive a timing offset configured by a base station, where the received timing offset is calculated and obtained based on a timing advance reported by the UE to the base station. The received timing offset may be configured by the base station through an SIB, and by the base station through UE-specific RRC signaling or MAC CE after the UE enters an RRC connected state.

Hereinafter, a common timing offset and a UE-specific timing offset will be described in detail.

In some examples, a common timing offset is configured by the base station through an SIB, and similar to the aforementioned configuration modes of a common TA, the base station may configure a cell-specific, beam footprint-specific, beam footprint group-specific or bandwidth part-specific common timing offset through an SIB. The common timing offset may be used for a timing relationship of uplink transmission and a timing relationship of broadcast channels before an RRC connected state such as PUSCH scheduled by RAR is established.

In some examples, after the UE is in an RRC connected state, the base station may configure a UE-specific timing offset through UE-specific RRC signaling or MAC CE. The UE-specific timing offset is only used for a timing relationship of unicast channels.

According to an embodiment of the present disclosure, the method described in connection with the above embodiments may be performed by the UE by communicating with a non-terrestrial base station in a non-terrestrial network. However, the present disclosure is not limited thereto, and it may be performed by the UE by communicating with other base stations except the non-terrestrial base station.

According to an embodiment of the present disclosure, there is provided a method performed by a base station in a wireless communication system, which may include:
receiving PRACH transmission of an initial random access procedure from a UE, wherein the PRACH transmission is transmitted based on a third timing advance determined by the UE based on a first timing advance configured by the base station and/or a second timing advance estimated by the UE; and
transmitting a timing advance control command indicated by an RAR to the UE,

wherein a timing advance indicated by the timing advance control command and the third timing advance are used for the UE to determine a fourth timing advance.

In some examples, the method may further include indicating timing advance drift information to the UE for the UE to update the fourth timing advance.

In some examples, the method may further include transmitting an absolute timing advance control command indicated by MAC CE to the UE, wherein a timing advance indicated by the absolute timing advance control command and a latest third timing advance are used for the UE to determine a latest fourth timing advance, where the latest third timing advance is determined by the UE based on a first timing advance latest configured by the base station and/or a second timing advance latest estimated by the UE.

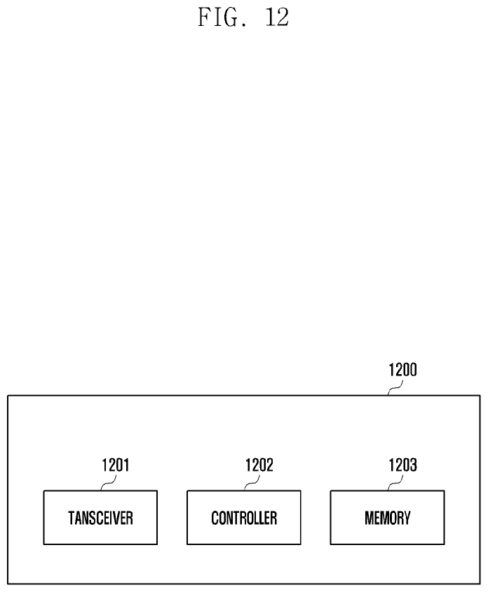

FIG. 12 illustrates a block diagram of an example UE according to an embodiment of the present disclosure.

Referring to FIG. 12, the UE 1200 includes a transceiver 1201, a controller 1202 and a memory 1203. Under the control of the controller 1202 (which may be implemented as one or more processors), the UE 1200 may be configured to perform related operations performed by the UE in the above-described methods. Although the transceiver 1201, the controller 1202, and the memory 1203 are shown as separate entities, they may be implemented as a single entity, such as a single chip. The transceiver 1201, the controller 1202, and the memory 1203 may be electrically connected or coupled to each other. The transceiver 1201 may transmit and receive signals to and from other network entities, such as a node (which may be a base station, a relay node, etc.) and/or another UE, etc. In some examples, the transceiver 1201 may be omitted. In this case, the controller 1202 may be configured to execute instructions (including computer programs) stored in the memory 1203 to control the overall operation of the UE 1200, thereby implementing the operations in the flows of the above methods.

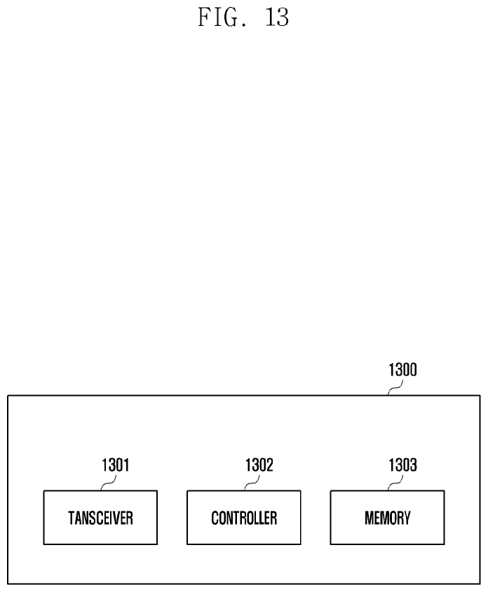

FIG. 13 illustrates a block diagram of an example base station according to an embodiment of the present disclosure.

Referring to FIG. 13, a base station 1300 includes a transceiver 1301, a controller 1302 and a memory 1303. Under the control of the controller 1302 (which may be implemented as one or more processors), the base station 1300 may be configured to perform related operations performed by the base station in the above-described methods. Although the transceiver 1301, the controller 1302 and the memory 1303 are shown as separate entities, they may be implemented as a single entity, such as a single chip. The transceiver 1301, the controller 1302, and the memory 1303 may be electrically connected or coupled to each other. The transceiver 1301 may transmit and receive signals to and from other network entities, such as another node (which may be, for example, a base station, a relay node, etc.) and/or a UE, etc. In some examples, the transceiver 1301 may be omitted. In this case, the controller 1302 may be configured to execute instructions (including computer programs) stored in the memory 1303 to control the overall operation of the base station 1300, thereby implementing the operations in the flows of the above methods.

According to an embodiment of the present disclosure, at least the following solution is also provided.

According to an aspect of the present disclosure, there is provided a method for channel transmission in a wireless communication network, including: determining a first time domain resource offset associated with the channel, wherein the first time domain resource offset is associated with a transmission delay; determining each of a plurality of time domain resource locations for transmitting the channel based on the first time domain resource offset; and transmitting the channel based on at least one of the plurality of time domain resource locations.

Optionally, determining a first time domain resource offset associated with the channel includes: determining the first time domain resource offset based on an additional delay offset associated with the transmission delay; and/or determining the first time domain resource offset based on a scheduling time domain offset indication associated with the channel and the additional delay offset.

Optionally, the additional delay offset is configured or predefined in units of downlink slot length or uplink slot length.

Optionally, the method further includes: starting and/or stopping a timer associated with the channel based on the transmission delay of the channel.

Optionally, the starting and/or stopping a timer associated with the channel based on the transmission delay of the channel further includes at least one of the following: determining a value range of the timer associated with the channel based on the transmission delay, and starting and/or stopping the timer based on the value range; and determining an start time and/or a stop time of the timer associated with the channel based on the transmission delay, and starting and/or stopping the timer based on the start time and/or stop time.

Optionally, the determining a value range of the timer associated with the channel based on the transmission delay includes at least one of the following: taking a first value range of the timer configured by system as the value range of the timer, wherein the first value range is determined based on the transmission delay of the channel; and determining a timing delay associated with the transmission delay based on the transmission delay of the channel, and determining a sum of the first value range of the timer configured by the system and the timing delay as the value range of the timer.

Optionally, the timing delay associated with the transmission delay includes at least one of the following: an additional delay offset associated with the transmission delay; a current timing advance value associated with the channel; a common timing advance value associated with the channel; a first additional delay configured by the system for autonomous retransmission of the channel; and a second additional delay adopted by a timer for hybrid automatic repeat request retransmission.

Optionally, the method further includes: determining a hybrid automatic repeat request process number associated with an initial time domain resource for transmitting the channel based on the transmission delay of the channel.

Optionally, the determining a hybrid automatic repeat request process number associated with an initial time domain resource for transmitting the channel based on the transmission delay of the channel includes: determining the hybrid automatic repeat request process number associated with the initial time domain resource for transmitting the channel according to the transmission delay of the channel and an actual transmission location of the channel.

Optionally, the determining a hybrid automatic repeat request process number associated with an initial time domain resource for transmitting the channel based on the transmission delay of the channel includes: determining an additional offset associated with the transmission delay based on the transmission delay; determining a current time domain location associated with the initial time domain resource based on the additional offset; and determining the hybrid automatic repeat request process number associated with the initial time domain resource for transmitting the channel based on the current time domain location.

Optionally, the transmitting the channel based on at least one of the plurality of time domain resource locations includes: determining a time domain resource location for transmitting the channel based on one or more time periods associated with the channel, wherein at least one of the one or more time periods is associated with the transmission delay.

Optionally, at least one of the one or more time periods is a hybrid automatic repeat request round-trip time configured by the system.

Optionally, a starting location associated with at least one of the one or more time periods is determined based on at least one of the following: determined based on a starting location of time domain resources scheduled by the system for the channel; determined based on a time location configured by the system corresponding to at least one of the one or more time periods; and determined based on a starting location of time domain resources actually used for transmitting the channel or a location where a received signal associated with the channel is detected.

Optionally, the method further includes determining a hybrid automatic repeat request type of each of a plurality of hybrid automatic repeat request processes associated with time domain resources for transmitting the channel, wherein the hybrid automatic repeat request type is determined according to at least one of the following: determining a hybrid automatic repeat request process type of each channel corresponding to the hybrid automatic repeat request process based on indication information in configuration information of the channel; determining the hybrid automatic repeat request process type of each hybrid automatic repeat request process based on a process number of the hybrid automatic repeat request process; determining the hybrid automatic repeat request process type of the hybrid automatic repeat request process based on indication information in downlink control information (DCI); determining the hybrid automatic repeat request process type of the hybrid automatic repeat request process based on a configuration of a timer related to retransmission of the channel; and determining a hybrid automatic repeat request process type of the hybrid automatic repeat request process based on a number or time of retransmissions associated with the channel.

According to another aspect of the present disclosure, there is provided an apparatus for channel transmission in a wireless communication network, including: an offset determination module configured to determine a first time domain resource offset associated with the channel, wherein the first time domain resource offset is associated with a transmission delay; a location determination module configured to determine each of a plurality of time domain resource locations for transmitting the channel based on the first time domain resource offset; and a transmitting module configured to transmit the channel based on at least one of the plurality of time domain resource locations.

According to another aspect of the present disclosure, there is provided an apparatus for channel transmission in a wireless communication network, including: a transceiver configured to transmit and receive signals to and from the outside; and a processor configured to control the transceiver to perform the methods according to the embodiments of the present disclosure.

According to yet another aspect of the present disclosure, there is provided a computer-readable medium having stored thereon computer-readable instructions for implementing methods according to embodiments of the present disclosure when executed by a processor.

According to the present disclosure, a time domain resource location for channel transmission is determined based on a transmission delay in a wireless communication network, so that time domain influence and performance degradation of a communication system caused by a large transmission delay can be effectively eliminated when the channel transmission is carried out in a wireless communication network with the large transmission delay.

The following continues to describe exemplary embodiments of the present disclosure with reference to the accompanying drawings.

Related research on a non-terrestrial network (NTN) is being carried out in 3GPP. With a wide-area coverage capability of satellites, NTN may enable operators to provide 5G commercial services in areas with underdeveloped terrestrial network infrastructure and realize 5G service continuity, especially in scenarios such as emergency communication, maritime communication, aviation communication and communication along railways. At the same time, research on narrow band internet of things (NB-IoT) and enhanced machine type communication (eMTC) through a non-terrestrial network is being carried out in 3GPP.

Compared with a terrestrial wireless communication network, because the satellite is extremely high from the terrestrial (for example, height of a low-orbit satellite is 600 km or 1200 km, and height of a synchronous satellite is close to 36,000 km), a transmission delay of a communication signal between a terrestrial terminal and the satellite is extremely large, even reaching tens or hundreds of milliseconds. This makes NTN need to use different physical layer technologies from the terrestrial network, such as TA for uplink transmission. The present disclosure mainly take uplink and downlink channel transmission such as uplink configured grant (CG) and downlink semi-persistent scheduling (SPS) as examples, to provide solutions suitable for a case of extremely large transmission delay.

Because a distance between a terrestrial UE (such as a mobile terminal) and a satellite is very large, there may be a large transmission delay. In order to make the base station follow the same downlink time when receiving signals transmitted by different UEs, for uplink scheduling such as physical uplink shared channel (PUSCH), physical uplink control channel (PUCCH), sounding reference signal (SRS), and other channels or signals, an additional delay offset, for example, an additional delay K_{offset}, is introduced. Generally, K_{offset} is equal to or approximately equal to the transmission delay. A common delay K_{offset} may be broadcast in system information for uplink transmission before a radio resource control (RRC) connection is established. After the UE establishes the RRC connection, the base station may further update the value of K_{offset} through UE-specific RRC signaling, or RRC signaling combined with a media access control (MAC) or downlink control information (DCI) dynamic indication. Particularly, different channels and signals may be configured with different K_{offset}. Generally, K_{offset} may be one or a combination of more of cell-specific, beam-specific, bandwidth part (BWP)-specific, UE-specific and channel/signal-specific.

Because the difference between uplink subcarrier spacing and downlink subcarrier spacing may lead to different time lengths of symbol and slot, K_{offset} is configured or predefined in units of downlink slot length or uplink slot length. A reference slot length (or a corresponding subcarrier spacing) may be configured or defined for K_{offset}. For example, the reference slot length may be a slot length corresponding to a subcarrier spacing of CORESET 0, or a slot length corresponding to an interval of initial synchronization signal block (SSB), or a slot length of a specific downlink BWP.

More specifically, K_{offset} may be added in the following ways:
With respect to a PUSCH scheduled by DCI, slot for the PUSCH scheduling may be

$$⌊ n \cdot \frac{{2}^{μ} PUSCH}{{2}^{μ} PDCCH} ⌋ + {K}_{2} + {K}_{offset} ;$$

With respect to PUSCH transmission scheduled by RAR, a UE may transmit the PUSCH at slot n+K₂+Δ+K_{offset}, where Δ is an additional offset for PUSCH transmission scheduled by RAR, which mainly for reserving enough time for the UE to decode PDSCH and analyze uplink grant in RAR;
With respect to a slot for transmitting HARQ-ACK on PUCCH, the UE may transmit PUCCH at slot n+K₁+K_{offset};
With respect to an activation time of MAC CE, a UE assumes that downlink configuration may take effect in the first slot after slot n+XNₛₗₒₜ^{subframe,μ}+K_{offset}, where Nₛₗₒₜ^{subframe,μ} is a number of slots in each subframe for subcarrier spacing μ, and X depends on a capability of UE;
With respect to the timing of a Channel State Information (CSI) reference resource, the CSI reference resource may be on the downlink slot n−n_{CSI}_{_{ref}}−K_{offset}; and
With respect to the timing of an aperiodic SRS, a UE may perform transmission on every triggered SRS resource of slot

$$⌊ n \cdot {2}^{\frac{{μ}_{SRS}}{{μ}_{PDCCH}}} ⌋ + k + {K}_{offset} ,$$

where k is the slot where PDCCH triggering the SRS is located.

Where, μ_{PUSCH}, μ_{PDCCH} and μ_{SRS} respectively represent the subcarrier spacing of the slots in which PUSCH, PDCCH (physical downlink control channel) and SRS are located; K₁ and K₂ are slot offsets from PDSCH to PUCCH and from PDSCH to DCI scheduled PUSCH, respectively; n is the location where respective reference signal is located; and n_{CSI}_{_{ref}} is a time offset from a CSI reference resource to DCI.

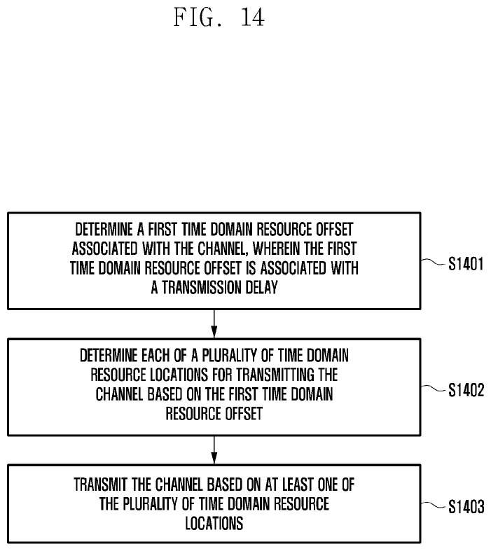

Next, FIG. 14 illustrates a schematic flowchart of a method for channel transmission in a wireless communication network according to an embodiment of the present disclosure. As shown in FIG. 14, at step S1401, a first time domain resource offset associated with a channel may be determined, where the first time domain resource offset may be associated with a transmission delay; at step S1402, each of a plurality of time domain resource locations for transmitting the channel may be determined based on the first time domain resource offset; and at step S1403, the channel may be transmitted based on at least one of the plurality of time domain resource locations. The method shown in FIG. 14 will be further described with embodiments.

According to an embodiment of the present disclosure, determining a first time domain resource offset associated with the channel may include: determining the first time domain resource offset based on an additional delay offset associated with the transmission delay; and/or determining the first time domain resource offset based on a scheduling time domain offset indication associated with the channel and the additional delay offset. In some embodiments, the scheduling time domain offset indication may be the slot offset K₁ or K₂ as described above, or may be other symbol offset or time offset indicated in DCI or system signaling, or may be a combination of slot offset and symbol offset. The above method may enable accurate scheduling for a system with a large transmission delay, so that locations of signals from different UEs when arriving at the base station can be aligned, thus simplifying the complexity of the base station.

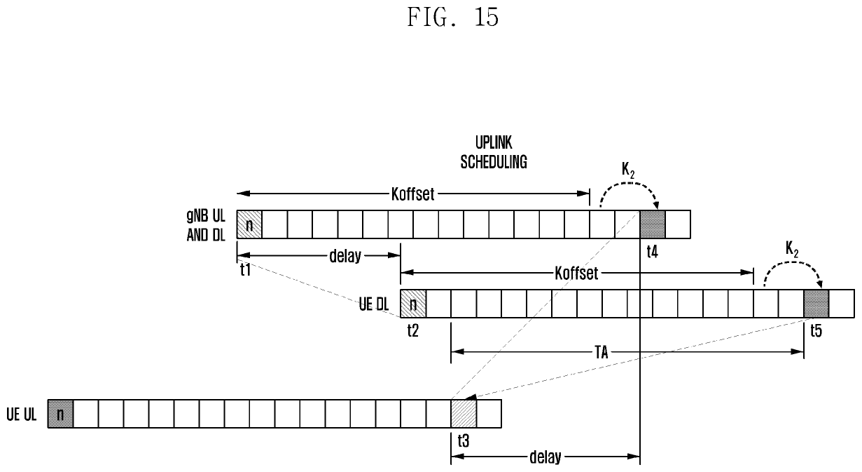

FIG. 15 illustrates a schematic diagram of an uplink scheduling according to an embodiment of the present disclosure. As shown in FIG. 15, a base station (e.g., gNB) transmits an uplink scheduling at slot n (time t1). Due to a transmission delay, a UE receives the uplink scheduling at time t2, and the UE considers the time t2 as slot n. The received uplink scheduling indicates to perform uplink transmission at slot n+K₂+K_{offset}. On the UE side, timing advance (TA) may be carried out on actual transmission, so that the UE may perform actual uplink transmission at time t3. In this way, the uplink transmission may arrive at the base station at slot n+K₂+K_{offset} (time t4) of the base station time. In this way, when scheduling multiple UEs, the base station does not need to compensate a delay for each UE.

The above description assumes that K_{offset} is one or more slots. Theoretically, K_{offset} may be equal to about twice the transmission delay. The transmission delay may be determined by a distance from the base station to the UE. Then, an actual transmission delay may not necessarily be an integer multiple of the slot. K_{offset} may also be calculated and expressed in other time units such as absolute time (e.g., millisecond (ms)) or the number of symbols. Particularly,

$${K}_{offset} = ⌊ \frac{TA}{time length of slot} ⌋ or ⌈ \frac{TA}{time length of slot} ⌉ ,$$

or a number of slots with a time closest to the TA value may be selected. The time length of slot may be a time length of uplink slot or a time length of downlink slot. The TA may be a common TA or a TA indicated in a TA command or a TA actually applied by the UE for the present or the latest uplink transmission.

In addition, for a dynamic scheduling, the scheduling of the base station may satisfy that a processing delay (for example, an actual time interval between PDCCH and the actual transmission of PUSCH, etc.) of the UE may be satisfied after the UE applies TA. Otherwise, the UE can be considered as wrong scheduling.

Time domain location of CG PUSCH.

There are two types of configured grant (CG) PUSCH in NR: Type 1 and Type 2. Type 1 CG PUSCH grant is configured through RRC, and Type 2 CG PUSCH grant is activated by DCI.

For Type 2 CG PUSCH, the time domain resource location of PUSCH on each period of the configured grant may be calculated according to a dynamically scheduled PUSCH.

In the current NR, for Type 2 configured grant (Type 2 CG), a MAC entity may consider that a sequentially N-th uplink grant starts at a symbol location calculated according to the following Equation A: [(SFN×numberOfSlotsPerFrame×numberOfSymbolsPerSlot)+(slot number in a frame×numberOfSymbolsPerSlot)+symbol number in a slot]=[(SFN_{start time}×numberOfSlotsPerFrame×numberOfSymbolsPerSlot+slot_{start time}×numberOfSymbolsPerSlot+symbol_{start time})+N×periodicity] modulo (1024×numberOfSlotsPerFrame×numberOfSymbolsPerSlot)

### (Equation A).

Where, numberOfSlotsPerFrame and numberOfSymbolsPerSlot are the number of consecutive slots in each frame and the number of consecutive symbols in each slot, respectively; periodicity is the period of uplink configured grant; SFN is the system frame number; and SFN_{start time}, slot_{start time} and symbol_{start time} are the numbers of the SFN, slot and symbol corresponding to the first transmission occasion of a (re-)initialized uplink configured grant PUSCH, respectively.

For Type 2 CG PUSCH with a large TA, the slot location corresponding to the first transmission occasion of PUSCH may be obtained by at least one of the following methods:
Method 1: the slot offset K₂ may be determined as a first time domain resource offset associated with a channel (e.g., uplink grant), and each time domain resource location for transmitting the channel may be determined based on the first time domain resource offset. For example, the slot_{start time} may be obtained only according to the slot offset K₂ indicated in DCI, regardless of K_{offset}. The slot offset K₂ indicated in DCI may be determined based on the transmission delay in the network. In this way, the implementation is relatively simple, and the implementation complexity of UE and base station may be reduced. Herein, the slot_{start time} may take a downlink slot received by the UE side (such as the slot corresponding to the downlink of the UE in FIG. 15) as reference; or the slot_{start time} may take an uplink slot of the UE after the UE applies TA (such as the slot corresponding to the uplink of the UE in FIG. 15) as reference; and
Method 2: the first time-domain resource offset associated with the uplink grant may be determined according to the slot offset K₂ and the additional delay offset K_{offset}, and each time domain resource location for transmitting the channel may be determined based on the first time domain resource offset. For example, the slot_{start time} may be obtained according to K_{offset} and the slot offset K₂ indicated in DCI. Particularly, the slot_{start time} may be obtained by

$$⌊ n \cdot \frac{{2}^{μ} PUSCH}{{2}^{μ} PDCCH} ⌋ + {K}_{2} + {K}_{offset} .$$

In this way, the processing of Type 2 CG PUSCH may be the same as the processing of dynamically scheduled PUSCH. At this time, the slot_{start time} may take a downlink slot received by the UE side (such as the slot corresponding to the downlink of the UE in FIG. 15) as reference; or the slot_{start time} may take an uplink slot of the UE after the UE applies TA (such as the slot corresponding to the uplink of the UE in FIG. 15) as reference.

Then, the starting symbol location of the N-th uplink grant may be obtained according to Equation A, so that each of a plurality of time domain resource locations for transmitting the uplink grant may be further determined.

In addition, for Method 2, it may be equivalent to keeping the calculation method of the symbol location of the uplink configured grant the same as that of Method 1, with directly modifying Equation A to the Equation B: [(SFN×numberOfSlotsPerFrame×numberOfSymbolsPerSlot)+(slot number in a frame×numberOfSymbolsPerSlot)+symbol number in a slot]=[(SFN_{start time}×numberOfSlotsPerFrame×numberOfSymbolsPerSlot+(slot_{start time}+K_{offset})×numberOfSymbolsPerSlot+symbol_{start time})+N×periodicity] modulo (1024×numberOfSlotsPerFrame×numberOfSymbolsPerSlot) (Equation B).

Where, K_{offset} may be configured in system message or UE-specific RRC signaling, and K_{offset} is in units of slots. Particularly, the K_{offset} for PUSCH may be obtained from configuration information of PUSCH, and may also be obtained from RRC signaling of CG PUSCH configuration. Configuring by RRC signaling the same or different K_{offset} value for each CG PUSCH in a plurality of CG PUSCHs may achieve a more flexible effect.

In case that K_{offset} is in units of symbols, Equation B′ may be used to calculate the starting symbol location of the N-th uplink grant: [(SFN×numberOfSlotsPerFrame×numberOfSymbolsPerSlot)+(slot number in a frame×numberOfSymbolsPerSlot)+symbol number in a slot]=[(SFN_{start time}×numberOfSlotsPerFrame×numberOfSymbolsPerSlot+slot_{start time}×numberOfSymbolsPerSlot+symbol_{start time}+K_{offset})+N×periodicity] modulo (1024×numberOfSlotsPerFrame×numberOfSymbolsPerSlot) (Equation B′).

In case that K_{offset} is in units of absolute time, a parameter in units of slots or symbols may be obtained according to K_{offset}, and the starting symbol location of the N-th uplink configured grant may be obtained by introducing the parameter into the above Equation B or Equation B′ respectively. Herein, a method of obtaining a parameter in units of slots or symbols according to K_{offset} may be dividing K_{offset} by a slot length or a symbol length and then rounding or taking the nearest value thereof. Herein, the slot length may be a downlink slot length or an uplink slot length.

Grant of Type 1 CG PUSCH is RRC configured. In the current NR system, for Type 1 configured grant (Type 1 CG), the MAC entity may consider to determine the starting symbol location for a sequentially N-th uplink grant according to the following Equation C: [(SFN×numberOfSlotsPerFrame×numberOfSymbolsPerSlot)+(slot number in a frame×numberOfSymbolsPerSlot)+symbol number in a slot]=(timeReferenceSFN×numberOfSlotsPerFrame×numberOfSymbolsPerSlot+timeDomainOffset×numberOfSymbolsPerSlot+S+N×periodicity) modulo (1024×numberOfSlotsPerFrame×numberOfSymbolsPerSlot) (Equation C).

Where, timeReferenceSFN is a reference SFN, timeDomainOffset is a slot offset to the reference SFN, and S is the location of a starting symbol in the time domain resource allocation.

For Type 1 CG PUSCH with a large TA, the symbol location of the N-th uplink grant may be obtained by at least one of the following methods:
Method 1: an actual timing advance may be considered when configuring timeDomainOffset. The actual timing advance value may be determined based on a transmission delay in the network. Then, the UE may obtain the symbol location of the N-th uplink grant by using the above Equation C. Herein, the timeDomainOffset may take a downlink slot received by the UE side (such as the slot corresponding to the downlink of the UE in FIG. 15) as reference. Or the timeDomainOffset may take an uplink slot of the UE after the UE applies TA (such as the slot corresponding to the uplink of the UE in FIG. 15) as reference. In Method 1, when the uplink grant arrives at the UE side, the time domain location where uplink PUSCH may be transmitted needs to be determined according to the time domain location of CG PUSCH resources and TA. That is, the UE needs to find an uplink slot location corresponding to the time domain resource location of the first CG PUSCH for transmission. Herein, the uplink slot location is obtained after applying the timing advance (TA) to the downlink slot location. As shown in FIG. 15, if an uplink service arrives at time t2, then the nearest CG PUSCH location is at time t3, and the corresponding downlink resource is the resource at time t5. At this time, the UE may calculate a HARQ process number according to the downlink slot corresponding to t5. Implementation of this method is relatively simple; and
Method 2: the first time-domain resource offset associated with the uplink grant may be determined according to the additional delay offset K_{offset}, and each time domain resource location for transmitting the channel may be determined based on the first time domain resource offset. For example, the symbol location of the N-th uplink grant may be calculated according to K_{offset}. This method has the same processing as that of dynamic scheduling and is relatively simple. Specifically, for the configuration in units of slots, the symbol location of the N-th uplink grant may be inferred according to the following Equation D: [(SFN×numberOfSlotsPerFrame×numberOfSymbolsPerSlot)+(slot number in a frame×numberOfSymbolsPerSlot)+symbol number in a slot]=(timeReferenceSFN×numberOfSlotsPerFrame×numberOfSymbolsPerSlot+(timeDomainOffset+K_{offset})×numberOfSymbolsPerSlot+S+N×periodicity) modulo (1024×numberOfSlotsPerFrame×numberOfSymbolsPerSlot) (Equation D).

Where, K_{offset} may be configured in system message or UE-specific RRC signaling. Particularly, the K_{offset} for PUSCH may be obtained from configuration information of PUSCH, and may also be obtained from RRC signaling of Type 1 CG PUSCH configuration, for example as shown in Table 1.

TABLE 1

| | |
|---|---|
| rrc-ConfiguredUplinkGrant | SEQUENCE { |
| timeDomainOffset | INTEGER (0..5119), |
| Koffset | ENUMERATED (x0,x1,x2,x3,...), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) OPTIONAL, |

-- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1..maxNrofPhysicalResourceBlocks- |

| | |
|---|---|
| 1) | OPTIONAL, -- Need R |

| | |
|---|---|
| pathlossReferenceIndex | INTEGER (0. maxNrofPUSCH- |

```
PathlossReferenceRSs-1),
  ...,
  [[
```

| | |
|---|---|
| pusch-RepTypeIndicator-r16 | ENUMERATED {pusch-RepTypeA,pusch- |

| | |
|---|---|
| RepTypeB} | OPTIONAL, -- Need M |

| | |
|---|---|
| frequencyHoppingPUSCH-RepTypeB-r16 | ENUMERATED {interRepetition, |

| | |
|---|---|
| interSlot} | OPTIONAL, -- Cond RepTypeB |

| | |
|---|---|
| timeReferenceSFN-r16 | ENUMERATED {sfn512} |

```
OPTIONAL -- Need R
  ]]
  }
```

Configuring the same or different K_{offset} value for each CG PUSCH in a plurality of CG PUSCHs may achieve a more flexible effect.

In case that K_{offset} is in units of symbols, Equation D′ may be used to calculate the starting symbol location of the N-th uplink grant: [(SFN×numberOfSlotsPerFrame×numberOfSymbolsPerSlot)+(slot number in a frame×numberOfSymbolsPerSlot)+symbol number in a slot]=(timeReferenceSFN×numberOfSlotsPerFrame×numberOfSymbolsPerSlot+timeDomainOffset×numberOfSymbolsPerSlot+S+K_{offset}+N×periodicity) modulo (1024×numberOfSlotsPerFrame×numberOfSymbolsPerSlot) (Equation D′).

In case that K_{offset} is in units of absolute time, a parameter in units of slots or symbols may be obtained according to K_{offset}, and the symbol location of the N-th uplink grant may be inferred by introducing the parameter into the above Equation D or Equation D′ respectively. Herein, a method of obtaining a parameter in units of slots or symbols according to K_{offset} may be dividing K_{offset} by a slot length or a symbol length and then rounding or taking the nearest value thereof. Herein, the slot length may be a downlink slot length or an uplink slot length.

Retransmission Timer.

With respect to CG PUSCH, a base station may configure an information element (IE) configuredGrantTimer, which indicates a timer, through RRC. If the timer is considered to be stopped, it means that the data uploaded by a corresponding HARQ process has been successfully received by the base station. In addition, the base station may also configure an information element (IE) cg-RetransmissionTimer, which indicates a timer for indicating the time when the UE cannot autonomously retransmit a relevant HARQ process, through RRC. Since there is a large transmission delay between the base station and the UE, it is necessary to modify at least one of these two timers to adapt to the transmission delay. According to an embodiment of the present disclosure, a timer associated with a channel may be started and/or stopped based on the transmission delay of the channel. In some embodiments, a value range of the timer associated with the transmission of the channel may be determined based on the transmission delay of the channel, and the timer may be started and/or stopped based on the value range. For example, a first value range of the timer configured by system may be taken as the value range of the timer, where the first value range may be determined based on the transmission delay of the channel. And/or, a timing delay associated with the transmission delay may be determined based on the transmission delay of the channel, and a sum of the first value range of the timer configured by the system and the timing delay may be determined as the value range of the timer. The above methods may be applicable to a system with a large transmission delay, so that the timers may cover the transmission delay, thus ensuring normal operations of the system.

Specifically, at least one of the above two timers may be calculated by at least one of the following methods:
Method 1: an additional delay (or timing delay) may be further added on the basis of the first value range of the timer configured by the system (for example, configured by the base station);
Method 2: the value range of the timer may be directly expanded (for example, by the system or the base station). For example, the system may directly determine the first value range of the timer based on the transmission delay of the channel and use the first value range of the timer as the timing range of the timer; and
Method 3: The value range of the timer may be expanded and an additional delay may be added simultaneously. That is, a combination of Method 1 and Method 2.

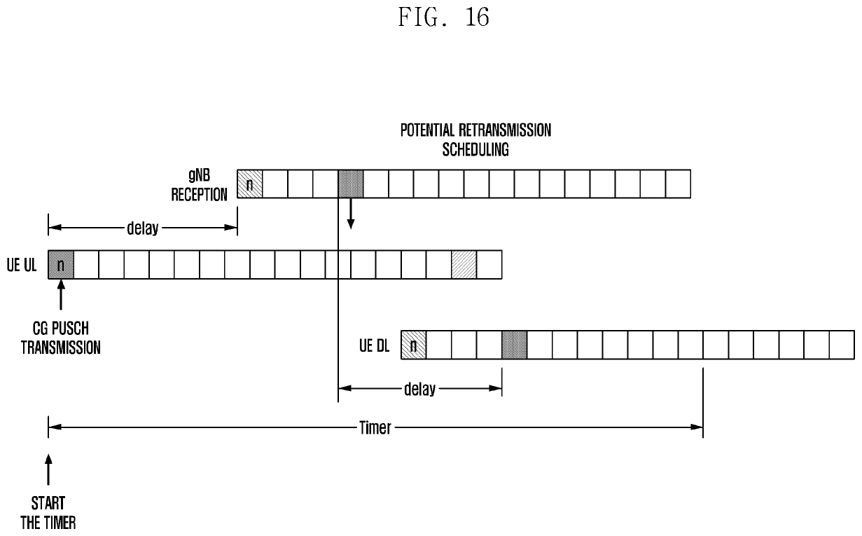

FIG. 16 illustrates a schematic diagram of expanding a value range of a timer according to an embodiment of the present disclosure. As shown in FIG. 16, a UE transmits an uplink grant at slot n and starts or restarts a timer at the same time. Then, the value range of the timer may be large enough, so that enough time can be reserved for a base station to schedule a potential retransmission. As shown in FIG. 16, this timer needs to be additionally added with at least twice a transmission delay. For example, the additional delay may be a value of a TA, or a value of the K_{offset} used for determining PUSCH time domain resource described above, or a value of TA/2. Herein, the TA may be a common TA or a TA actually applied by the UE. Further, the additional delay may be separately configured by specific signaling.

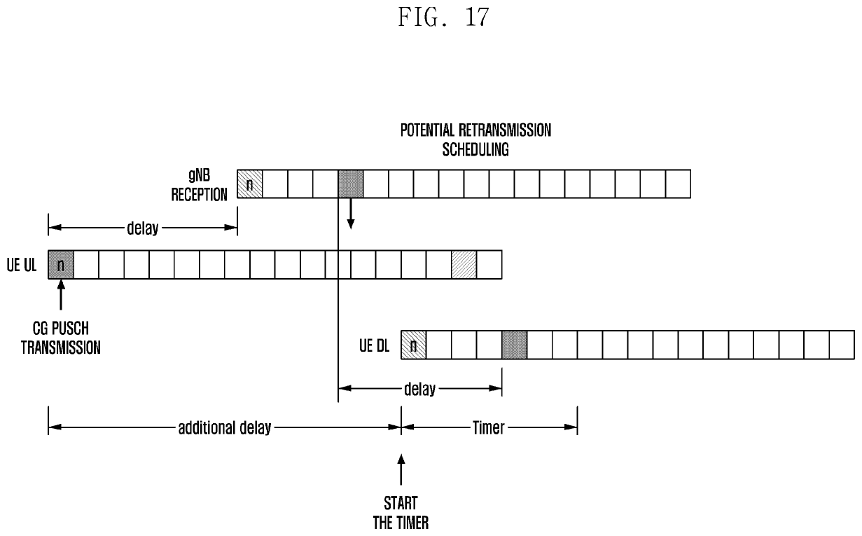

Additionally, or alternatively, a start time and/or a stop time of the timer associated with the channel may be determined based on the transmission delay of the channel, and the timer may be started and/or stopped based on the start time and/or stop time. Large transmission delay may be accommodated by modifying the start time and/or stop time of the timer. Specifically, the timer may be started after an additional delay. FIG. 17 illustrates a schematic diagram of changing a start time of a timer according to an embodiment of the present disclosure. As shown in FIG. 17, the UE may transmit an uplink grant at slot n, and may start or restart the timer after an additional delay. Particularly, this timer may be the configuredGrantTimer.

Particularly, starting and/or stopping of the configuredGrantTimer and/or cg-Retransmission Timer may be performed by at least one of the following methods:
In case an uplink grant of CG PUSCH is received in RAR, or an uplink grant is received in PDCCH and a New Data Indicator (NDI) of corresponding to a HARQ process thereof is 1 (retransmission), the configuredGrantTimer for the corresponding HARQ process is started (or restarted) after an additional delay. At this time, if cg-Retransmission Timer is configured, the cg-RetransmissionTimer for the corresponding HARQ process may be stopped directly or after an additional delay;
In case an uplink grant is received in PDCCH and an NDI corresponding to a HARQ process thereof is 0, and the DCI is an active DCI of Type 2 CG PUSCH, if the configuredGrantTimer and/or cg-Retransmission Timer are running, at least one of the two timers is stopped directly or after an additional delay;
In case an uplink grant is received in PDCCH and the corresponding transmission is an initial transmission, the configuredGrantTimer and/or cg-RetransmissionTimer are started or restarted after an additional delay; and
In case a downlink feedback is received in a HARQ process, the configuredGrantTimer and/or cg-RetransmissionTimer for the HARQ process may be stopped directly or after an additional delay.

Preferably, the UE may start a timer after the additional delay, but may not stop a timer after the additional delay.

The additional delay (i.e., timing delay) described in the above methods may be at least one of the following: a K_{offset} corresponding to the CG PUSCH (configured by the above methods); or a current TA associated with channel transmission; or a common TA associated with channel transmission; or a first additional delay additionally configured by the base station (or system) for autonomous retransmission of CG PUSCH; or the same configuration as a second additional delay adopted by a timer for calculation for HARQ retransmission. Therein, the common TA may be configured by system information or UE-specific RRC signaling. The UE current TA may be obtained by adding the common TA and a UE-specific TA transmitted from the base station to the UE. Therein, the UE-specific TA may include a TA in RAR and a TA in a subsequent TA command.

Calculation of HARQ-ID.

In the NR system, for a configured uplink grant, if harq-ProcID-Offset2 and cg-Retransmission Timer are not configured, a HARQ process ID related to the first symbol for uplink transmission may be inferred according to the following Equation: HARQ Process ID=[floor(CURRENT_symbol/periodicity)] modulo nrofHARQ-Processes.

Where, periodicity is a period configured by system, and nrofHARQ-Processes is the number of hybrid automatic repeat request (HARQ) processes in the configured uplink grant.

For a configured uplink grant configured with a HARQ process ID offset harq-ProcID-Offset2, the hybrid automatic repeat request process number (HARQ process ID) related to the first symbol for uplink transmission may be inferred according to the following Equation: HARQ Process ID=[floor(CURRENT_symbol/periodicity)] modulo nrofHARQ-Processes+harq-ProcID-Offset2.

Where, the location of the current symbol is: CURRENT_symbol=(SFN×numberOfSlotsPerFrame×numberOfSymbolsPerSlot+slot in the frame in which the current symbol is located×numberOfSymbolsPerSlot+symbol in the slot in which the current symbol is located) (Equation E).

Where, numberOfSlotsPerFrame and numberOfSymbolsPerSlot are the number of consecutive slots in each frame and the number of consecutive symbols in each slot, respectively.

According to an embodiment of the present disclosure, a hybrid automatic repeat request process number associated with an initial time domain resource for transmitting a channel may be determined based on a transmission delay of the channel. Herein, the initial time domain resource may be, for example, the first symbol for uplink transmission as described above.

For a system with a large TA or a large transmission delay, a location of a current symbol for determining HARQ ID in CG PUSCH may be defined by one of the following two methods:
Method 1: the hybrid automatic repeat request process number associated with the initial time domain resource for transmitting the channel may be determined according to the transmission delay of the channel and an actual transmission location of the channel. For example, a location of a current symbol may be defined as the location of the downlink symbol corresponding to a grant received by the UE, and calculated by Equation E. Note that this location may not be the actual uplink transmission location. For example, referring to FIG. 15, the actual uplink transmission location of the UE is a slot corresponding to time t3, and the location of the downlink symbol corresponding to the grant received by the UE may be a slot corresponding to time t5. Herein, t5 is a time after t3 applies a TA. The UE determines a corresponding downlink slot location according to the actual transmission location and the applied TA (or the transmission delay), and determines a HARQ process number corresponding to the PUSCH according to the determined downlink slot location. For the base station, the base station may calculate the corresponding slot according to the actual transmission and reception slot locations, thus reducing the complexity of the base station;
Method 2: an additional offset associated with the transmission delay may be determined based on the transmission delay; a current time domain location associated with the initial time domain resource may be determined based on the additional offset; and the hybrid automatic repeat request process number associated with the initial time domain resource for transmitting the channel may be determined based on the current time domain location. For example, the current symbol location may be obtained according to the following Equation F: CURRENT_symbol=(SFN×numberOfSlotsPerFrame×numberOfSymbolsPerSlot+(slot in the frame in which the current symbol is located+X)×numberOfSymbolsPerSlot+symbol in the slot in which the current symbol is located)

### (Equation F).

Where X may be an additional offset in units of slots. This offset may be obtained based on the transmission delay of the channel, for example, the offset may be K_{offset} for obtaining the time domain transmission location of PUSCH or −K_{offset}, or a TA used for transmitting PUSCH, or a common TA, or a parameter configured by additional signaling.

Similarly, if X is a value in units of symbols, the current symbol location may be obtained by the following Equation: CURRENT_symbol=(SFN×numberOfSlotsPerFrame×numberOfSymbolsPerSlot+(slot in the frame in which the current symbol is located×numberOfSymbolsPerSlot+symbol in the slot in which the current symbol is located+X) (Equation F′).

In case that X is in units of absolute time, a parameter in units of slots or symbols may be obtained according to X, and the current symbol location may be obtained by introducing the parameter into the above Equation F or Equation F′ respectively. Herein, a method of obtaining a parameter in units of slots or symbols according to X may be dividing X by a slot length or a symbol length and then rounding or taking the nearest value thereof. Herein, the slot length may be a downlink slot length or an uplink slot length.

The above methods can prevent the base station from calculating a HARQ process for each UE, and the existing methods for calculating the HARQ process number may be reused.

Configuration for multiple CG PUSCHs or DL SPSs.

Due to the existence of a large transmission delay, design of a system needs to avoid transmitting multiple DCI activated CG PUSCHs or DL SPSs, especially for a case where multiple CG PUSCH or multiple DL SPS configurations exist. In Rel-16, joint deactivation is introduced for multiple CG PUSCHs or multiple DL SPSs. Then, multiple joint activations may be further introduced. Furthermore, one or more CG PUSCHs and DL SPSs may be activated simultaneously by one DCI.

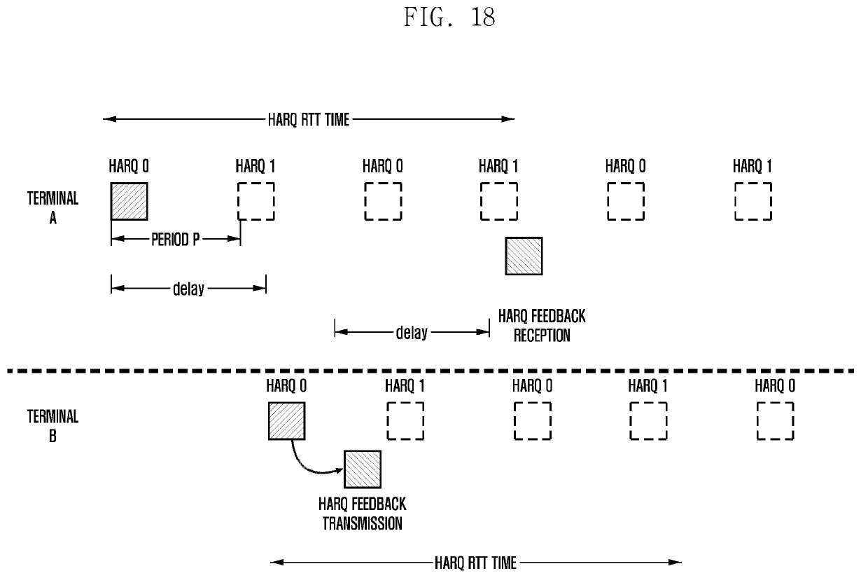

In addition, due to a long transmission delay, because the existing CG PUSCH and DL SPS are both configured with equal periods, with a limited number of HARQ processes, a round trip time (RTT) of one HARQ may span multiple periods of the same HARQ process. Specifically, FIG. 18 illustrates a schematic diagram in which transmission and reception for multiple HARQ processes exist according to an embodiment of the present disclosure. As shown in FIG. 18, terminal A (which may be a base station or a UE) performs transmission on a resource where HARQ 0 is located, and after a certain transmission delay, terminal B (which may be a UE or a base station) receives the transmission and performs feedback. Similarly, after a certain transmission delay, terminal A receives the HARQ feedback transmitted by terminal B. Generally, the base station or system may configure or predefine uplink and downlink HARQ RTT time to the UE, for example:
drx-HARQ-RTT-TimerDL (for every downlink HARQ process except broadcast process): a minimum duration of a downlink grant for this HARQ retransmission expected by a MAC entity; and
drx-HARQ-RTT-TimerUL (each uplink HARQ process): a minimum duration before a HARQ retransmission of an uplink grant expected by a MAC entity.

In case that an actual HARQ RTT time of terminal A spans multiple time domain resources of HARQ 0, a UE or a base station may not be able to transmit or receive on a HARQ 0 resource within the HARQ RTT time due to limited capabilities of base station and the UE or system design. In this case, it may be solved by one of the following methods:
Method A: PDSCH reception and/or PUSCH transmission of the same HARQ process may not be performed during the actual HARQ RTT time.

Furthermore, this method is only applicable to a HARQ process that supports HARQ feedback, and is not applicable to a process that does not perform HARQ feedback. Or this method is applicable to a case no matter whether there is HARQ feedback or not. Whether to perform transmission and/or reception at a process within the actual HARQ RTT time may be decided according to the configuration of the base station. For example, whether to perform transmission or reception of the same HARQ process may be decided by the HARQ ID number and/or configuration in a configured grant to which the resource belongs.

As shown in the example in FIG. 18, terminal A may not perform transmission on a resource for HARQ 0 within the HARQ RTT time. And/or if a signal is detected on a resource for a certain HARQ, reception on a resource for the same HARQ process number may not be performed within the HARQ RTT time. Particularly, the starting times of the HARQ RTT times for terminal A and terminal B may be the starting times of the transmission and the reception, respectively. Particularly, for a PDSCH, if reception of HARQ on the corresponding HARQ process is not needed, an effect of power saving can be achieved.

In addition, the UE may be stipulated by a protocol or configured by the system that, if the UE detects downlink signals on resources of a certain HARQ process and feeds back, the UE may feedback ACK for PDSCH resources corresponding to the HARQ process within the RTT time corresponding to the HARQ process, or the UE may not feedback. It can be specifically determined according to whether the feedback is a separate HARQ feedback and/or according to the type of a HARQ codebook. For example, NACK is used for a Type 1 HARQ codebook. For another example, if there is only feedback for DL SPS, no feedback may be performed, otherwise, NACK may be used.

Method B: the time domain resource location for transmitting the channel may be determined based on one or more time periods associated with the channel, where at least one of the one or more time periods is associated with the transmission delay of the channel. For example, a time period may be a period or an offset, or a length of a timer. For example, multiple parameters (e.g., time period, period, or offset) may be configured to determine the location of the DL SPS and/or UL CG time domain resources.

Particularly, a period (or time period) P2 for determining the starting location of each group of PUSCH and/or PDSCH resources may be configured. And a period (or time period) P1 for determining the time domain location of each resource in a group of PUSCH and/or PDSCH. In an example, the period P1 may be defined as an offset between multiple PDSCH or PUSCH resources. The above period (or time period) or offset may be configured by the base station (such as through RRC configuration and/or DCI indication) or predefined. In an example, if one DCI schedules multiple PUSCHs and/or multiple PDSCHs, the time domain locations of the multiple PUSCHs and/or multiple PDSCHs may be decided according to an indication in the DCI. For example, the offset of each time domain resource may be indicated in DCI, or each time domain resource location may be inferred according to the predefined or configured offset and the number of PUSCHs and/or PDSCHs, or a time domain resource allocation (TDRA) table that may indicate multiple time domain resource locations may be configured. Particularly, it may be predefined that if the period P1 is 0, then multiple PUSCHs and/or PDSCHs are nominally continuously transmitted. Also, they may be continuous transmission actually, or may be continuous transmission nominally in symbols or slots corresponding to uplink or downlink.

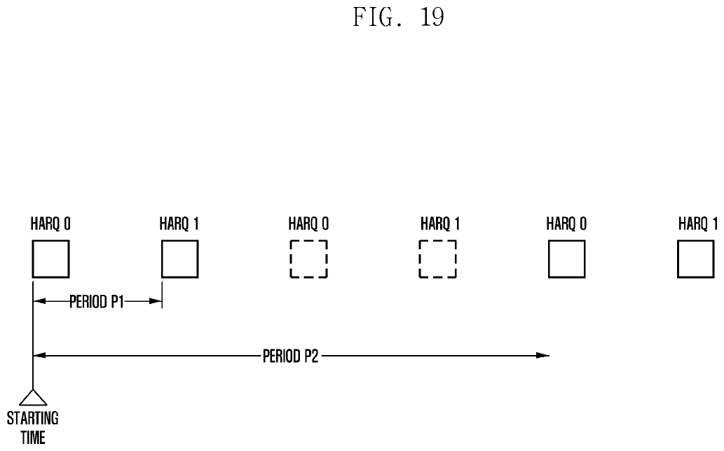

In a specific implementation, the period P1 may be an existing period of CG PUSCH and/or DL SPS configured in the NR system. While the period P2 is an additional period for defining whether an available resource is valid. For example, FIG. 19 illustrates a schematic diagram of configuring multiple periods for channel transmission according to an embodiment of the present disclosure. As shown in FIG. 19, only the first group of resources of each HARQ process starting from the period P2 is valid. Particularly, the period P2 may be a configuration related to the transmission delay. For example, the period P2 is a HARQ RTT time, or equal to a HARQ RTT time to which a Koffset is added, or is the configuredGrantTimer, or is a TA, etc.

In addition, the starting location (or starting time) of the above time period, period or offset may be determined according to at least one of the following methods:
Method 1): it may be determined based on a starting location of the time domain resource for the channel scheduled by the system. For example, it may be determined according to the first PUSCH and/or PDSCH activated by DCI;
Method 2): it may be determined based on a time location corresponding to at least one of one or more time periods configured by the system. For example, it may be determined according to a relative time location of a specific time period configured by the system, for example, one or more of SFN, slot and symbol number of the starting location of the time period. The method is also applicable to Type 1 CG PUSCH;
Method 3): it may be determined according to a starting location of the time domain resource of an actually transmitted or detected received signal. For example, it may be determined according to a location of the actually transmitted PUSCH and/or a location of the detected PDSCH. The method may support more flexible CG PUSCH transmission. This method may be another expression or configuration implementation of the above method A. That is, at least one of the one or more time periods may be the hybrid automatic repeat request round trip time HARQ RTT configured by the system.

Method C: it is defined or configured by the base station that transmission or reception and/or feedback for resources corresponding to each DL SPS and/or UL CG is performed. At this time, it is necessary to define a specific feedback method for a case with repeated HARQ process. For example, a HARQ-ACK codebook may be defined according to the slot number. Or, according to a timing relationship of PDSCH of HARQ-ACK, the location of actual transmission of the PDSCH of the corresponding feedback may be determined. Particularly, the location of actual transmission of the PDSCH may be determined by pushing forward the HARQ-ACK transmission time n by t time units. In which the t time units are time offsets from PDSCH indicated in DCI of the corresponding PDSCH scheduling to PUCCH carrying HARQ-ACK.

Processing for HARQ-less.

Because of a large RTT, it is necessary to introduce multiple HARQ processes to fill a time gap caused by a transmission delay, or introduce HARQ-less transmission. This method is also called blind retransmission. Then, for CG PUSCH and/or DL SPS, a hybrid automatic repeat request type of each of a plurality of hybrid automatic repeat request processes associated with time domain resources for transmitting channels may be determined according to at least one of the following methods, for example, whether it is HARQ-less transmission may be determined according to at least one of the following methods:
The hybrid automatic repeat request process type of each channel corresponding to the hybrid automatic repeat request process may be determined based on indication information in configuration information of the channel. For example, whether to introduce HARQ-less transmission may be configured for each CG PUSCH and/or DL SPS respectively. Since there may be multiple HARQ processes in each configuration, if configured, the multiple HARQ processes are all transmission with HARQ feedback or are all HARQ-less transmission;
The hybrid automatic repeat request process type of each hybrid automatic repeat request process may be determined based on a process number of the hybrid automatic repeat request process. For example, whether there is HARQ feedback may be decided according to the HARQ process ID of each CG PUSCH and/or DL SPS. Specifically, whether one or more HARQ processes have HARQ feedback may be predefined or configured by the base station. For example, the base station configures HARQ process ID 0 to HARQ process ID 3 as HARQ processes without feedback. For a case where multiple HARQ processes exist, whether each HARQ process has HARQ feedback is further determined according to at least one of the following methods:
   According to configuration corresponding to a HARQ ID of a specific one of the CG PUSCH and/or DL SPS configuration (e.g., the smallest (first) HARQ ID), it is determined whether all HARQ processes in the CG PUSCH and/or DL SPS configuration have HARQ feedback or not. The advantage of this is that the processing of a UE and base station is relatively simple, and
   According to each HARQ ID in the configuration, it is determined whether the HARQ process has HARQ feedback or not. The advantage of this is flexible;
The hybrid automatic repeat request process type of the hybrid automatic repeat request process may be determined based on indication information in downlink control information (DCI). For example, it may be decided whether one or more corresponding HARQ processes have no HARQ feedback transmission according to an indication of activating DCI. Specifically, it may be based on an additional indication field in DCI, DCI format, Radio Network Temporary Identity (RNTI) scrambled by DCI, or configuration corresponding to DCI format. This method is more flexible and may share methods with dynamic scheduling;
The hybrid automatic repeat request process type of the hybrid automatic repeat request process may be determined based on a configuration of a timer related to retransmission of the channel. For example, it may be decided according to whether a retransmission related timer is configured. For example, for CG PUSCH, if configuredGrantTimer is not configured or the value is 0, it is considered that retransmission is not needed. If only cg-Retransmission Timer is configured, a UE autonomous retransmission after the timer expires may be achieved. For another example, whether the uplink or downlink does not need HARQ feedback is determined according to whether a Discontinuous Reception (DRX) retransmission timer is configured. For example, if the DRX retransmission timer is not configured, HARQ feedback is not needed. This method can save signaling overhead; and
The hybrid automatic repeat request process type of the hybrid automatic repeat request process may be determined based on a number or time of retransmissions associated with the channel. For example, it may be determined according to a number or time of repetitions. HARQ feedback is not needed if the number or time of repetitions of the corresponding PUSCH or PDSCH is greater than a threshold. This method is more flexible and can support dynamically changing whether HARQ feedback is needed or not for a HARQ process without DCI overhead.

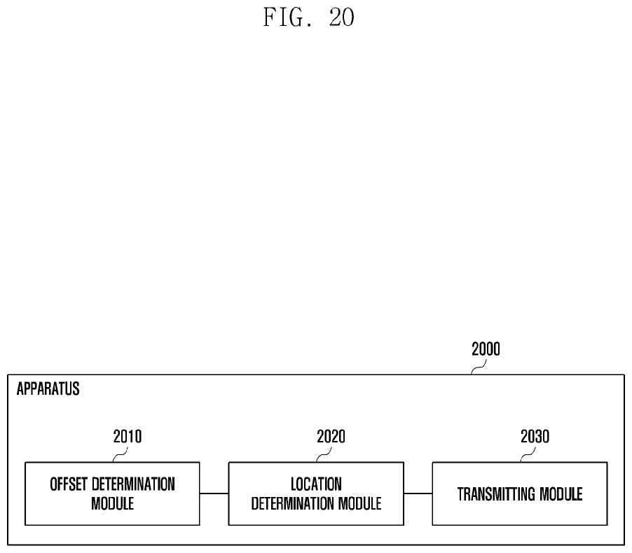

Next, FIG. 20 illustrates a structural block diagram of an apparatus 2000 for channel transmission in a wireless communication network according to an embodiment of the present disclosure.

As shown in FIG. 20, the apparatus 2000 may include an offset determination module 2010, a location determination module 2020 and a transmitting module 2030. The apparatus 2000 may implement the methods for channel transmission according to the above embodiments of the present disclosure. For example, the offset determination module 2010 may be configured to determine a first time domain resource offset associated with a channel, wherein the first time domain resource offset is associated with a transmission delay; the location determination module 2020 may be configured to determine each of a plurality of time domain resource locations for transmitting the channel based on the first time domain resource offset; and the transmitting module 2030 may be configured to transmit the channel based on the plurality of time domain resource locations.

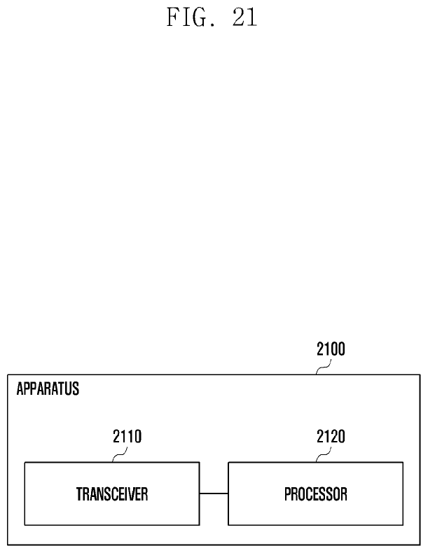

FIG. 21 illustrates a schematic diagram of an apparatus 2100 for channel transmission in a wireless communication network according to an embodiment of the present disclosure. As shown in FIG. 21, the device 2100 may include a transceiver 2110 and a processor 2120. The transceiver 2110 may be configured to transmit and receive signals to and from the outside. The processor 2120 may be configured to control the transceiver 2110 to perform the methods for channel transmission in a wireless communication network according to embodiments of the present disclosure.

Various embodiments of the disclosure may be implemented as computer readable codes embodied on a computer readable recording medium from a specific perspective. The computer readable recording medium is any data storage device that may store data readable by a computer system. An example of the computer readable recording medium may include a read-only memory (ROM), a random access memory (RAM), a compact disk read-only memory (CD-ROM), a magnetic tape, a floppy disk, an optical data storage device, a carrier wave (e.g., data transmission via an Internet), and the like. Computer readable recording media may be distributed by computer systems connected via a network, and thus the computer readable codes may be stored and executed in a distributed manner. Furthermore, functional programs, codes, and code segments for implementing various embodiments of the disclosure may be easily explained by those skilled in the art to which the embodiments of the disclosure are applied.

It will be understood that the embodiments of the disclosure may be implemented in a form of hardware, software, or a combination of hardware and software. Software may be stored as program instructions or computer readable codes executable on a processor on a non-transitory computer readable medium. An example of the non-transitory computer readable recording medium includes a magnetic storage medium (e.g., a ROM, a floppy disk, a hard disk, etc.) and an optical recording medium (e.g., a CD-ROM, a digital video disk (DVD), etc.). Non-transitory computer readable recording media may also be distributed on computer systems coupled by a network, so that the computer readable codes are stored and executed in a distributed manner. The medium can be read by a computer, stored in a memory, and executed by a processor. Various embodiments may be implemented by a computer or a portable terminal including a controller and a memory, and the memory may be an example of a non-transitory computer readable recording medium suitable for storing program(s) having instructions to implement the embodiments of the disclosure. The disclosure may be realized by a program having codes for specifically implementing the apparatus and method described in the claims, which is stored in a machine (or computer) readable storage medium. The program may be electronically carried on any medium, such as a communication signal transferred via a wired or wireless connection, and the disclosure suitably includes equivalents thereof.

It can be understood by those skilled in the art that the present disclosure includes devices for performing one or more of the operations described in this application. These devices may be specially designed and manufactured for a desired purpose, or they may include known devices in general-purpose computers. These devices have computer programs stored therein that are selectively activated or reconfigured. Such a computer program may be stored in a device (e.g., computer) readable medium or in any type of medium suitable for storing electronic instructions and respectively coupled to a bus.

It can be understood by those skilled in the art that each block in these structural diagrams and/or block diagrams and/or flow diagrams and combinations of blocks in these structural diagrams and/or block diagrams and/or flow diagrams may be implemented by computer program instructions. It can be understood by those skilled in the art that these computer program instructions may be provided to a processor of a general-purpose computer, a specially designed computer or other programmable data processing means for implementation, so that the solutions specified in the block or blocks of the structural diagrams and/or block diagrams and/or flow diagrams of the present disclosure may be executed by the processor of the computer or other programmable data processing means.

It can be understood by those skilled in the art that steps, arrangements and solutions in various operations, methods and processes that have been discussed in the present disclosure can be alternated, changed, combined or deleted. Further, other steps, arrangements and solutions in various operations, methods and processes that have been discussed in the present disclosure can also be alternated, changed, rearranged, decomposed, combined or deleted. Further, steps, arrangements and solutions in various operations, methods and processes disclosed in the prior art can also be alternated, changed, rearranged, decomposed, combined or deleted.

The above is only part of the examples of the present disclosure, and it should be pointed out that for those of ordinary skill in the art, without departing from the principles of the present disclosure, several improvements and embellishments can be made, and these improvements and embellishments should also be regarded as within the protection scope of the present disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment in a wireless communication system, the method including:
determining a third timing advance based on at least one of a first timing advance configured by a base station or a second timing advance estimated by the user equipment, wherein the third timing advance is used for a physical random access channel (PRACH) transmission for an initial random access procedure;
receiving a timing advance control command indicated by the base station through a random access response (RAR); and
obtaining a fourth timing advance according to a timing advance indicated by the timing advance control command and the third timing advance.

2. The method according to claim 1, further including:
updating the fourth timing advance based on timing advance drift information.

3. The method according to claim 2, wherein the timing advance drift information includes at least one of:
common timing advance drift information configured by the base station through a system information block (SIB), UE-specific radio resource control (RRC) signaling, or a media access control (MAC) control element (CE); or
user equipment-specific timing advance drift information configured by the base station through user equipment-specific RRC signaling or the MAC CE, or estimated by the user equipment.

4. The method according to claim 1, further including:
receiving an absolute timing advance control command indicated by the base station through a MAC CE; and
obtaining a latest fourth timing advance according to a timing advance indicated by the received absolute timing advance control command and a latest third timing advance,
wherein the latest third timing advance is determined based on at least one of a first timing advance latest configured by the base station or a second timing advance latest estimated by the user equipment.

5. The method according to claim 1, wherein the first timing advance is configured by:
the base station through a system information block (SIB); or
the base station through an SIB, and, after the UE enters an RRC connected state, the first timing advance is configured by the base station through user equipment-specific RRC signaling or a MAC CE,
wherein a value configured by the user equipment-specific RRC signaling or the MAC CE is used to replace a value configured by the SIB.

6. The method according to claim 1, further comprising:
when an interval between a time for using the first timing advance and a specific time exceeds a preset range, updating the first timing advance based on drift information of the first timing advance configured by the base station; and
applying the updated first timing advance for the PRACH transmission for the initial random access procedure,
wherein the first timing advance is associated with a specific time.

7. The method according to claim 1, wherein the first timing advance comprises configurations including at least one of:
a cell-specific first timing advance;
a beam footprint-specific first timing advance;
a beam footprint group-specific first timing advance; or
a bandwidth part-specific first timing advance.

8. The method according to claim 1, further comprising estimating the second timing advance based on at least one of:
a geographical location difference between the user equipment and the base station;
a reference time difference between the user equipment and the base station; or
the geographical location difference and the reference time difference between the user equipment and the base station,
wherein a geographical location of the base station is determined based on satellite ephemeris-related information indicated by the base station, and a reference time of the base station is indicated by the base station through an SIB.

9. The method according to claim 1, wherein:
when an estimation mode for the second timing advance is determined based on a geographical location difference between the user equipment and the base station, the third timing advance includes the first timing advance; and
when the estimation mode for the second timing advance is determined based on a reference time difference between the user equipment and the base station, the third timing advance does not include the first timing advance, and
wherein the estimation mode in which the second timing advance is estimated by the user equipment is related to an operation to determine the third timing advance whether including the first timing advance configured by the base station.

10. The method according to claim 9, further comprising reporting, to the base station, a user equipment capability corresponding to the estimation mode for the second timing advance.

11. The method according to claim 10, further comprising:
reporting, to the base station, the estimation mode for the second timing advance through user equipment-specific RRC signaling or a MAC CE; or
implicitly reporting, to the base station, the estimation mode for the second timing advance through a PRACH resource.

12. The method according to claim 1, further comprising reporting, to the base station, the second timing advance.

13. The method according to claim 12, further comprising reporting, to the base station, a variation of the second timing advance related to a last reported second timing advance.

14. The method according to claim 13, further comprising:
triggering a reporting operation for the second timing advance when an instruction to trigger the reporting operation of a timing advance indicated by the base station is received;
triggering the reporting operation for the second timing advance when a difference between the latest estimated second timing advance and the last reported second timing advance exceeds a preset range; or
triggering the reporting operation for the second timing advance when a timer for controlling the reporting operation of a timing advance expires, wherein the timer for controlling the reporting operation of the timing advance starts or restarts after the second timing advance is reported every time.

15. The method according to claim 1, further comprising receiving, from the base station, an offset of the second timing advance to correct the second timing advance using the offset of the second timing advance.
